(19) United States
(12) Patent Application Publication
(10) Pub. No.: US 2013/0085780 A1
(43) Pub. Date: Apr. 4, 2013

(54) HEALTH CARE INFORMATION MANAGEMENT

(71) Applicants: Andrew Scott Braunstein, Weston, MA (US); Claudia Baker, Lexington, NC (US); Kelley Chapman, Wakefield, MA (US); Robert Anders, Hudson, MA (US); Michael Stern, Needham, MA (US)

(72) Inventors: Andrew Scott Braunstein, Weston, MA (US); Claudia Baker, Lexington, NC (US); Kelley Chapman, Wakefield, MA (US); Robert Anders, Hudson, MA (US); Michael Stern, Needham, MA (US)

(21) Appl. No.: 13/632,706

(22) Filed: Oct. 1, 2012

Related U.S. Application Data
(60) Provisional application No. 61/541,649, filed on Sep. 30, 2011.

(51) Int. Cl. G06Q 50/24

(52) U.S. Cl. 705/3

(57) ABSTRACT

A method, computer program product, and system is described. A patient condition associated with a patient record is identified based upon, at least in part, a first input associated with the patient record. A point-of-care prompt is provided based upon, at least in part, the patient condition and clinical authority information. A point-of-care input, associated with at least in part, one or more of education material, a condition assessment, co-morbidity information, a diagnosis protocol, a treatment protocol, medication information, clinical order information, visit order information, patient resource information, and care planning information, is received. Treatment information is provided based upon, at least in part, the point-of-care input and one or more of education material, a condition assessment, co-morbidity information, a diagnosis protocol, a treatment protocol, medication information, clinical order information, visit order information, patient resource information, and care planning information.

### CROSS-REFERENCE TO RELATED APPLICATIONS

This application claims priority to provisional application 61/541,649, filed Sep. 30, 2011, the entire disclosure of which is incorporated herein by reference.

### TECHNICAL FIELD

This disclosure relates to managing health care information.

### BACKGROUND

As part of providing health care services, health care professionals may interact directly with patients and other individuals. In certain instances, these interactions may occur outside traditional health care fora such as hospitals and doctor's offices and may include non-doctor professionals as well as doctors. For example, nurses and other professionals may sometimes visit patients in off-site settings such as the patients' homes in order to conduct diagnostic evaluations, provide educational information, advance courses of treatment, and so on. Patients may suffer from a variety of diseases, ailments, and so on (generally “conditions”) that may be related to one or more specific illnesses and may be associated with a variety of types of information, including medication information, visit frequency information, course-of-treatment information, educational information, diagnostic information, and so on.

### BRIEF SUMMARY OF THE DISCLOSURE

According to one aspect of the disclosure, a computer-implemented method includes identifying, by one or more computing devices, a patient condition associated with a patient record based upon, at least in part, a first input associated with the patient record. The method further includes providing, by the one or more computing devices, a point-of-care prompt based upon, at least in part, the patient condition and clinical authority information. The method further includes receiving in response to the point-of-care prompt, by the one or more computing devices, a point-of-care input associated with, at least in part, one or more of a first education material, a first condition assessment, first co-morbidity information, a first diagnosis protocol, a first treatment protocol, first medication information, first clinical order information, first visit order information, patient resource information, and first care planning information. The method further includes providing treatment information, by the one or more computing devices, based upon, at least in part, the point-of-care input, wherein the treatment information is associated with clinical authority information and one or more of a second education material, a second condition assessment, a second co-morbidity, a second diagnosis protocol, a second treatment protocol, second medication information, second clinical order information, second visit order information, second care planning information, and benchmarking information.

One or more of the following features may be included. The method may include identifying one or more of historical diagnosis information and historical treatment information. Providing the treatment information may be based upon, at least in part, one or more of the historical diagnosis information and the historical treatment information.

Providing the point-of-care prompt may include providing a hierarchical input architecture associated one or more patient condition characteristics. The one or more patient condition characteristics may be based upon, at least in part, one or more of the clinical authority information and the patient condition. The method may further include receiving a selection of one or more nested categories associated with the hierarchical input architecture. The method may further include providing one or more additional input prompts based upon, at least in part, the selection, wherein the one or more additional input prompts are associated with the one or more condition characteristics. The method may further include identifying one or more coding requirements based upon, at least in part, the selection of the one or more nested categories. The method may further include determining whether the one or more coding requirements has been met. The method may further include providing a drawing template based upon, at least in part, the selection of the one or more nested categories.

The method may further include receiving a first clinical order including a text-based clinical order. The method may further include associating the first clinical order with an order category. The method may further include associating date tracking information with the first clinical order. The method may further include determining whether an event associated with the date tracking information occurs before passage of a deadline associated with the date tracking information. The method may further include, if the event does not occur before the passage of the deadline, providing a prompt associated with non-occurrence of the event. The method may further include, if the event does occur before the passage of the deadline, associating an indicator of an occurrence of the event with the patient record. The method may include identifying a need associated with the patient condition. The method may include associating with the first clinical order a recommended order element associated with the need.

The method may further include receiving a second clinical order including text-based clinical order. The method may further include identifying an association between the first clinical order and the second clinical order. The method may further include merging the first clinical order and the second clinical order based upon, at least in part, identifying the association.

The first medication information may include one or more of a medication type and medication dose regimen information. The second medication information may include one or more recommendations associated with an additional medication, wherein the additional medication is associated with one or more of the medication type, the medication dose regimen information, and a characteristic associated with the patient condition. The method may include providing teaching information regarding one or more of the medication type and the medication dose regimen information.

The method may further include receiving medication usage information. The method may further include determining a compliance level associated with a medication regimen based upon, at least in part, the medication dose regimen information and the medication usage information. The method may further include plotting the compliance level with respect to one or more medication effect parameters.

The second treatment protocol may include one or more identifications of unnecessary treatment activities. The method may further include providing the treatment information at one or more of the point of care and a remote location.

The method may further include receiving one or more compliance indications associated with one or more aspects of a recommended treatment course, wherein the treatment information includes the recommend treatment course. The method may further include identifying one or more instances of non-compliance with the one or more aspects of a recommended treatment course based upon, at least in part, comparing the one or more indications of compliance with the recommended treatment course. The method may further include providing a visual indicator of the one or more instances of non-compliance. The visual indicator may include a representation of one or more historical compliance trends.

The method may further include providing one or more recommendations for a treatment session based upon, at least in part, one or more of the clinical authority information, identifying the one or more instances of non-compliance, and receiving one or more clinical orders. Providing the one or more recommendations may include grouping a set of clinical orders for presentation by subject matter category. Providing the one or more recommendations may include providing relevant education materials, based upon, at least in part, one or more of the clinical authority information and the patient condition.

The method may further include identifying a plurality of visit tracks. The method may further include determining the second visit order information based upon, at least in part, identifying the plurality of visit tracks. The second visit order information may include a recommendation associated with the plurality of visit tracks.

The method may further include determining benchmarking information based upon, at least in part, comparing patient treatment course information with normalized treatment course information. The method may further include identifying a treatment threshold associated with one or more critical indicators. The method may further include providing an alert based upon, at least in part, one or more of determining that a first aspect of the patient treatment course information has met the threshold and determining that a second aspect of the patient treatment course information is projected to meet the threshold.

According to another aspect of the disclosure, a computer program product resides on a computer readable storage medium and has a plurality of instructions stored on it. When executed by a processor, the instructions cause the processor to perform operations including identifying a patient condition associated with a patient record based upon, at least in part, a first input associated with the patient record. The operations further include providing a point-of-care prompt based upon, at least in part, the patient condition and clinical authority information. The operations further include receiving in response to the point-of-care prompt a point-of-care input associated with, at least in part, one or more of a first education material, a first condition assessment, first co-morbidity information, a first diagnosis protocol, a first treatment protocol, first medication information, first clinical order information, first visit order information, patient resource information, and first care planning information. The operations further include providing treatment information based upon, at least in part, the point-of-care input, wherein the treatment information is associated with clinical authority information and one or more of a second education material, a second condition assessment, a second co-morbidity, a second diagnosis protocol, a second treatment protocol, second medication information, second clinical order information, second visit order information, second care planning information, and benchmarking information.

According to another aspect of the disclosure, a computing system includes one or more processor and one or more memory architecture coupled with the at one or more processors. The one or more processors are configured to identify a patient condition associated with a patient record based upon, at least in part, a first input associated with the patient record. The one or more processors are further configured to provide a point-of-care prompt based upon, at least in part, the patient condition and clinical authority information. The one or more processors are further configured to receive in response to the point-of-care prompt a point-of-care input associated with, at least in part, one or more of a first education material, a first condition assessment, first co-morbidity information, a first diagnosis protocol, a first treatment protocol, first medication information, first clinical order information, first visit order information, patient resource information, and first care planning information. The one or more processors are further configured to provide treatment information based upon, at least in part, the point-of-care input, wherein the treatment information is associated with clinical authority information and one or more of a second education material, a second condition assessment, a second co-morbidity, a second diagnosis protocol, a second treatment protocol, second medication information, second clinical order information, second visit order information, second care planning information, and benchmarking information.

The details of one or more implementations are set forth in the accompanying drawings and the description below. Other features and advantages will become apparent from the description, the drawings, and the claims.

### BRIEF DESCRIPTION OF THE SEVERAL VIEWS OF THE DRAWINGS

FIG. 1 is a diagrammatic view of a health care information management process coupled to a distributed computing network;

FIG. 2 is a flowchart of a process executed by the health care information management process of FIG. 1;

FIG. 3 is a flowchart of a process executed by the health care information management process of FIG. 1.

FIG. 4 is a diagrammatic view of an implementation of the health care information management process of FIG. 1.

FIG. 5 is a diagrammatic view of an implementation of the health care information management process of FIG. 1;

FIG. 6 is a diagrammatic view of an implementation of the health care information management process of FIG. 1;

FIG. 7 is a diagrammatic view of an implementation of the health care information management process of FIG. 1.

FIG. 8 is a diagrammatic view of an implementation of the health care information management process of FIG. 1.

FIG. 9 is a flowchart of a process executed by the health care information management process of FIG. 1;

FIG. 10 is a flowchart of a process executed by the health care information management process of FIG. 1;

FIG. 11 is a diagrammatic view of an implementation of the health care information management process of FIG. 1.

FIG. 12 is a diagrammatic view of an implementation of the health care information management process of FIG. 1.

FIG. 13 is a diagrammatic view of an implementation of the health care information management process of FIG. 1;

FIG. 14 is a diagrammatic view of an implementation of the health care information management process of FIG. 1;

FIG. 15 is a flowchart of a process executed by the health care information management process of FIG. 1.

FIG. 16 is a diagrammatic view of an implementation of the health care information management process of FIG. 1.

FIG. 17 is a diagrammatic view of an implementation of the health care information management process of FIG. 1;

FIG. 18 is a diagrammatic view of an implementation of the health care information management process of FIG. 1;

FIG. 19 is a diagrammatic view of an implementation of the health care information management process of FIG. 1.

FIG. 20 is a diagrammatic view of an implementation of the health care information management process of FIG. 1.

FIG. 21 is a diagrammatic view of an implementation of the health care information management process of FIG. 1;

FIG. 22 is a diagrammatic view of an implementation of the health care information management process of FIG. 1;

FIG. 23 is a flowchart of a process executed by the health care information management process of FIG. 1.

FIG. 24 is a diagrammatic view of an implementation of the health care information management process of FIG. 1.

Like reference symbols in the various drawings indicate like elements.

### DETAILED DESCRIPTION OF THE PREFERRED EMBODIMENTS

Delivering health care services to patients and managing the delivery of healthcare services to patients (including managing billing-related aspects of health care services) may include interactions with patients (and others) in a variety of locations. Further, delivering health care services and managing that delivery may involve large amounts of information relating to patient conditions (including historical conditions), treatment regimens, compliance with treatment, diagnoses, services rendered, and so on. Efficient and effective management of this information may lead to lower costs, better treatment, and better patient outcomes.

Managing health care information may be useful in a variety of settings, including “off-site” locations such as patients' homes. Providing care at patients' homes may be a cost-effective method of providing health care services, as Home Health Agencies (“HHAs”) and other at-home provider agencies may charge patients and/or insurers far less for a given amount of time than hospitals, doctor offices, and so on. There may be further advantages to off-site care as well. For example, if a patient is treated (e.g., diagnosed, assessed, educated, medicated, and so on) in the patient's home, the health care provider may have information-gathering opportunities that may not be available in other settings. For example, a health care provider may be more able to assess a patient's compliance with medication and other treatment regimes in a patient's home than in a hospital or doctor's office. This may result, for example, because the patient may be more comfortable discussing certain topics in a familiar setting. Further, by providing services in a patient's home (or other off-site location), a health care provider may have access to various types of information that would not be available at a hospital, doctor's office, and so on. For example, in a patient's home, a health care provider may have access to direct evidence of lifestyle preferences (e.g., presence of exercise equipment, cleanliness of residence, types of food present, mobility aids present, and so on), medication (e.g., whether medication supplies are being depleted at an acceptable rate), and so on.

In managing health care using off-site visits, however, it may be difficult to manage the high volume of information associated with care for a particular patient and/or patient group. For example, diseases and other conditions may include a variety of related chronic and acute conditions that must be treated in different ways and which may vary from patient to patient. For example, diabetes may be divided in to a number of sub-classifications that may include, in some cases, completely opposite indications—e.g., one diabetic patient may suffer from elevated blood sugar whereas another diabetic patient may suffer from depressed blood sugar. Further, co-morbidities—multiple problems that may be interrelated and/or associated with a particular disease—may be very common among patients. For example, patients suffering from diabetes may often also suffer from heart conditions. Co-morbidities may complicate the necessary diagnostic and treatment steps and options and may, in some instances, even suggest competing treatment requirements (e.g., one condition counsels more exercise while a co-morbidity counsels more rest). Additional off-site (e.g., at-home) care providers may sometimes employ individual providers that do not have advanced degrees or training and who may therefore lack specific and detailed expertise regarding a variety of medical issues. For these and other reasons, it may be useful to provide a flexible, evidence-based system to assist health care providers in various aspects of their off-site (and other) work.

A health care information management (“HCIM”) process may assist health care providers (and others) in these and other aspects. For example, an HCIM process may comprehensively support and optimize treatment for co-morbidities by guiding the acquisition and recording of various health-related information from patients and facilitating effective follow-up on recommended treatment regimes. An HCIM process, through the effective management of information, may expand treatment to more fully encompass chronic disease management in addition to acute episodes. For example, an HCIM process may guide collection of data that may be used to assess patient progress (or regression) over time in a comprehensive manner and may facilitate comparison of patient status (and progress/regression) with various other patient populations. An HCIM process may facilitate care planning by identifying objective and measurable goals for patient care and whether those goals have been met. An HCIM process may assist health care professionals in managing drug regimens by tracking medication compliance and comparing such compliance with key measures based on recommended drug protocols. An HCIM process may facilitate effective, timely, and proper coding of treatment, diagnoses and other information, thereby supporting faster and more successful billing and cost reimbursement.

An HCIM process may further optimize visit frequency through intelligent calendar management that includes awareness of key patient indicators and treatment (and diagnostic) milestones. An HCIM process may facilitate organized and specific clinical order entry and may suggest goals and/or interventions associated with particular coded conditions. An HCIM process may facilitate the use of free-form text entries in clinical orders without the loss of useful categorization, and may present previously-entered orders in effective ways to facilitate efficient provision of care at subsequent visits. An HCIM process may facilitate patients accepting greater ownership of and responsibility for their health care by facilitating recordation of patient-gathered information and integration of that information into master patient records. Further, an HCIM process may facilitate delivery of customized educational and treatment information and may assessment of patient health care activities occurring outside the context of health care visits and appointments.

An HCIM process may provide guided compliance information for a health care worker during off-site (and other) visits, including providing single documents adapted for specific conditions, treatments and/or patients, customizable drawings and illustrations to facilitate diagnosis and education, and scorecards and other representations to indicate patient trends. An HCIM process may provide a variety of patient- and condition-specific information dashboards, to facilitate evaluation of patient treatment over time and with respect to other relevant populations. In light of these and other functionalities, an HCIM process may therefore facilitate delivery and tracking of high quality and low cost medical care through health care providers having wide ranges of familiarity with condition- and patient-specific information.

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer usable medium may be a computer readable signal medium or a computer readable storage medium. A computer-usable, or computer-readable, storage medium (including a storage device associated with a computing device or client electronic device) may be, for example, but not limited to, an electronic, magnetic, optical, electromagnetic, infrared, or semiconductor system, apparatus, or device, or any suitable combination of the foregoing. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device. In the context of this document, a computer-usable, or computer-readable, storage medium may be any tangible medium that can contain, or store a program for use by or in connection with the instruction execution system, apparatus, or device.

A computer readable signal medium may include a propagated data signal with computer readable program coded embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

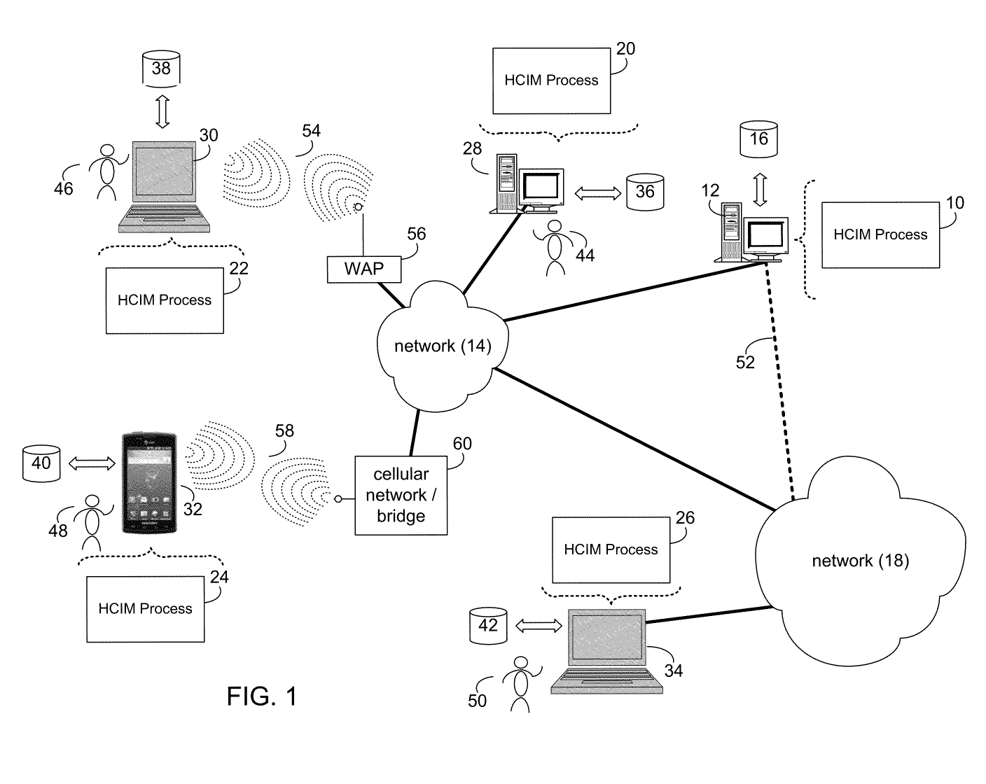

Referring now to FIG. 1, an HCIM process may be coupled to a computer or computer network. For example, server HCIM process 10 may reside on and may be executed by server computer 12, which may be connected to network 14 (e.g., the Internet or a local area network). Examples of server computer 12 may include, but are not limited to: a personal computer, a server computer, a series of server computers, a mini computer, and/or a mainframe computer. Server computer 12 may be a web server (or a series of servers) running a network operating system, examples of which may include but are not limited to: Microsoft® Windows Server® Novell® Netware®; or Red Hat® Linux®, for example. (Microsoft and Windows are registered trademarks of Microsoft Corporation in the United States, other countries or both; Novell and NetWare are registered trademarks of Novell Corporation in the United States, other countries or both; Red Hat is a registered trademark of Red Hat Corporation in the United States, other countries or both; and Linux is a registered trademark of Linus Torvalds in the United States, other countries or both.)

The instruction sets and subroutines of server HCIM process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft® IIS, Novell® Web Server™, or Apache® Web Server, that allows for access to server computer 12 (via network 14) using one or more protocols, examples of which may include but are not limited to HTTP (i.e., HyperText Transfer Protocol), SIP (i.e., session initiation protocol), and the Lotus® Sametime® VP protocol. (Webserver is a trademark of Novell Corporation in the United States, other countries, or both; Apache is a registered trademarks of Apache Software Foundation in the United States, other countries, or both; Lotus and Sametime are registered trademarks of International Business Machine Corp. in the United States, other countries, or both.) Network 14 may be connected to one or more secondary networks (e.g., network 18), examples of which may include but are not limited to: a local area network; a wide area network; or an intranet, for example.

Client HCIM processes 20, 22, 24, 26 may reside on and may be executed by client electronic devices 28, 30, 32, and/or 34 (respectively), examples of which may include but are not limited to personal computer 28, laptop computer 30, a data-enabled mobile telephone 32, notebook computer 34, personal digital assistant (not shown), smart phone (not shown) and a dedicated network device (not shown), for example. Client electronic devices 28, 30, 32, 34 may each be coupled to network 14 and/or network 18 and may each execute an operating system, examples of which may include but are not limited to Microsoft® Windows®, Microsoft Windows CE®, Red Hat® Linux®, or a custom operating system.

The instruction sets and subroutines of client HCIM processes 20, 22, 24, 26, which may be stored on storage devices 36, 38, 40, 42 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Storage devices 36, 38, 40, 42 may include but are not limited to: hard disk drives; tape drives; optical drives; RAID arrays; random access memories (RAM); read-only memories (ROM); compact flash (CF) storage devices; secure digital (SD) storage devices; and memory stick storage devices.

In an embodiment, the HCIM process may be a server-side process (e.g., which may be implemented via server HCIM process 10), in which all of the functionality of the HCIM process may be executed on a server computer (e.g., server computer 12). In an embodiment, the HCIM process may be a client-side process (e.g., which may be implemented via one or more of client HCIM processes 20, 22, 24, 26), in which all of the functionality of the HCIM process may be executed on a client computing device (e.g., one or more of client electronic devices 28, 30, 32, 34). In an embodiment, the HCIM process may be a hybrid server-client process (e.g., which may be implemented by server HCIM process 10 and one or more of client HCIM processes 20, 22, 24, 26), in which at least a portion of the functionality of the HCIM process may be implemented via server computer 12 and at least a portion of the functionality of the HCIM process may be implemented via one or more client computing devices (e.g., one or more of client electronic devices 28, 30, 32, 34).

Users 44, 46, 48, 50 may access an HCIM process in various ways. For example, these users may access server HCIM process 10 directly through the device on which a client process (e.g., client HCIM processes 20, 22, 24, 26) is executed, namely client electronic devices 28, 30, 32, 34. Users 44, 46,48, 50 may access server HCIM process 10 directly through network 14 and/or through secondary network 18. Further, server computer 12 (i.e., the computer that executes server HCIM process 10) may be connected to network 14 through secondary network 18, as illustrated with phantom link line 52. Users 44, 46,48, 50 may also access a client or server CCA in similar ways.

The various client electronic devices may be directly or indirectly coupled to network 14 (or network 18). For example, personal computer 28 is shown directly coupled to network 14 via a hardwired network connection. Further, notebook computer 34 is shown directly coupled to secondary network 18 via a hardwired network connection. Laptop computer 30 is shown wirelessly coupled to network 14 via wireless communication channel 54 established between laptop computer 30 and wireless access point (“WAP”) 56, which is shown directly coupled to network 14. WAP 56 may be, for example, an IEEE 802.11a, 802.11b, 802.11g, 802.11n, Wi-Fi, and/or Bluetooth device that is capable of establishing wireless communication channel 54 between laptop computer 30 and WAP 56. Data-enabled mobile telephone 32 is shown wirelessly coupled to network 14 via wireless communication channel 58 established between data-enabled mobile telephone 32 and cellular network/bridge 60, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

For the following discussion, client HCIM process 20 will be described for illustrative purposes. It will be understood that client HCIM process 20 may, for example, interact and/or communicate with a server HCIM process such as server HCIM process 10 and/or may be executed within one or more applications that allow for communication with other server and/or client HCIM processes. HCIM process 20 may be utilized as part of or in conjunction with a variety of other server and/or client applications (not shown) including applications that facilitate accessing and/or storing information associated with HCIM process 20 (e.g., on storage device 16). This is not intended to be a limitation of this disclosure, as other configurations are possible. For example, some implementations may include one or more of client HCIM processes 22, 24, 26 or server HCIM process 10 in place of or in addition to client HCIM process 20. Additionally/alternatively, HCIM process 20 may include stand-alone client processes and/or stand-alone server processes, HCIM process may be utilized as part of or in conjunction with other applications (not shown), and so on.

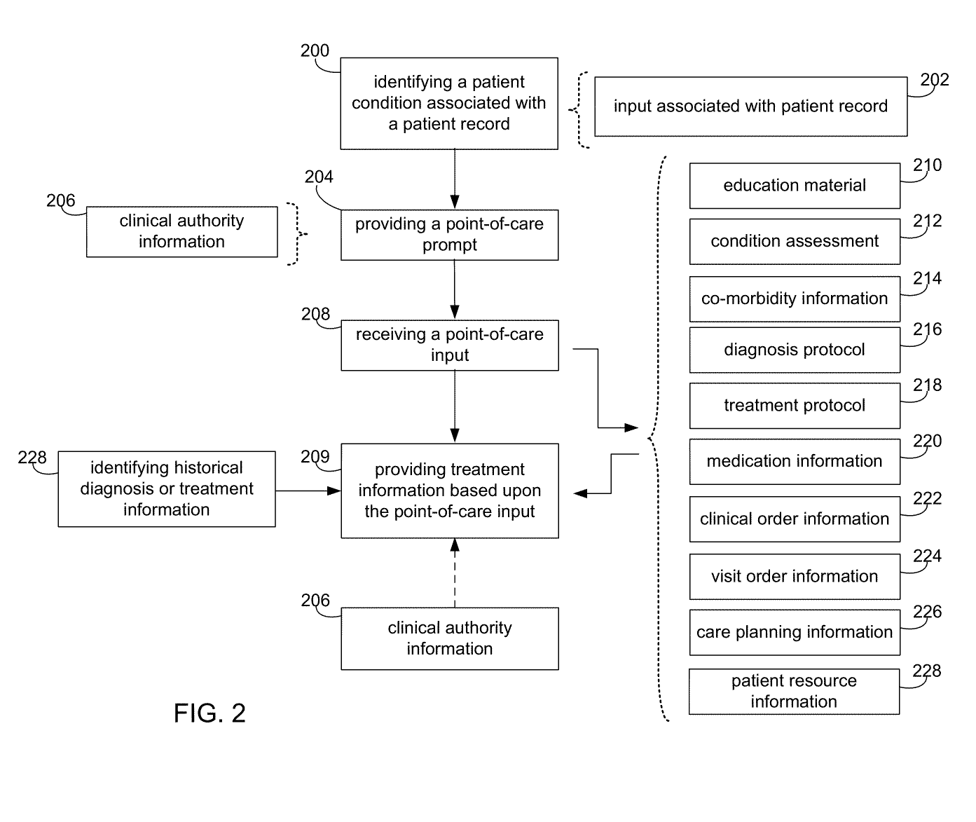

Referring now also to FIG. 2, there is shown a diagrammatic view of an example process that may be implemented by an HCIM process, e.g., client HCIM process 20. HCIM process 20 may identify 200 a patient condition associated with a patient record. A patient condition may be any variety of medical classifications or identifications, including diseases, ailments, syndromes, general or specific physical or mental states, and so on and may relate to a past, present or predicted state or status of a patient. A patient record may be a record of patient information including personal information, past and present treatment and other medical information, past and present conditions of the patient, family medical history, and so on. A patient record may sometimes include financial information, such as billing information, as well as medical and other information. A patient record may identify medical personnel associated with a patient and/or a condition (or other record information). For example, a patient record may identify a doctor or other medical professional assigned to a patient. A patient record may be stored electronically (e.g., as a database record on storage device 16) and may be accessible in whole or in part by HCIM process 20.

HCIM process 20 may identify 200 a patient condition based upon, at least in part, a first input 202 associated with the patient record. A health care provider (e.g., a doctor, a nurse, a physician's assistant or other health care professional) may enter a variety of inputs in a variety of ways to identify a patient and/or a patient condition. For example, a provider may enter a patient name or other identification (e.g., a patient number, a phone number, and so on) in order to access a particular patient record. In certain embodiments, HCIM process 20 may identify a particular patient condition (or all relevant patient conditions) based upon an input identifying the patient. In certain embodiments, HCIM process 20 may identify one or more specific patient conditions, potentially out of many additional patient conditions, based on an input associated with the specific conditions. For example, HCIM process 20 may identify a specific patient condition based on a provider selecting the condition from a list of conditions associated with the patient or based on an input indicating the start of a particular provider activity (e.g., a home visit) that is associated with a particular condition (e.g., a home visit that appears on a calendar associated with the patient as relating to a specific condition).

HCIM process 20 may provide 204 a point-of-care prompt. As used herein, “point-of-care” refers to a location at which medical care (e.g., diagnosis, education, counseling, treatment, and so on) is provided. As such, a point-of-care prompt refers to a prompt for an input that is provided at the location at which medical care is provided. In other words, in certain embodiments, an HCIM process may be utilized by a provider as part of or in close association with providing care to a patient. An HCIM process 20 may be useful, for example, to manage medical information in off-site situations (i.e., treatments occurring at home rather than in a hospital or a doctor's office, and so on). As such, in certain embodiments a provider may visit a patient in the patient's home in order to provide effective care and may be presented a prompt for an input by HCIM process 20 while at the patient's home.

HCIM process 20 may provide 204 a point-of-care prompt based upon, at least in part, the identified 200 patient condition. An HCIM process may be useful to assist providers by providing guidance, recommendations, and other information during provision of care to a patient. As such, HCIM process 20 may prompt 204 a provider for an input that is relevant to a patient being treated at a given time. HCIM process 20 may determine that a particular input (or input category) may be relevant to a patient, and that prompting 204 a provider for that input may be appropriate, based on a variety of information. For example, HCIM process 20 may determine, based on a patient condition, as more fully described below, that particular information (or information type) may be useful in providing recommendations, guidance, and so on and may therefore provide 204 a prompt for input relating to that information. For example, an input related to aspects of treatment, symptoms and other factors associated with diabetes may be relevant to the providing of care to a diabetic patient and HCIM process 20 may therefore provide 204 a prompt for input associated with such information.

Similarly, HCIM process 20 may provide 204 a point-of-care prompt based upon, at least in part, clinical authority information 206. In the medical field, various sources of information may be considered clinical authorities. For example, a group of specialists, a department in a hospital, a research organization, a medical school department, a medical journal, a medical organization, and so on, may be considered as having authoritative information associated with a particular medical condition (or an aspect thereof), a particular patient, a particular treatment, a particular procedure, and so on. As such, in certain embodiments, HCIM process 20 may determine the information (or information type) that may be relevant to providing services to a particular patient based upon information drawn from such authorities—i.e., clinical authority information—by way, for example, of a journal, website, database, computer record, or other publication associated with the clinical authority. In this way, based on clinical authority information 206, HCIM process 20 may provide 204 a prompt for an input that is directed toward information that may be specifically relevant to a particular patient condition, a particular provision of services, or a particular patient, and so on.

As noted above, a variety of groups may be considered clinical authorities, depending, in certain embodiments, on the nature of the services to be provided, the relevant patient condition, the relevant patient, and so on. For example, the American Diabetes Association may be considered a clinical authority with respect to diabetes conditions, and the American Lung Association may be considered a clinical authority with respect to lung conditions, and so on. As such, information relating to a particular lung patient or lung condition that may be relevant to HCIM process 20 and for which HCIM process 20 may therefore provide 204 a point-of-care prompt may be determined by HCIM process 20 based on clinical authority information 206 from the American Lung Association. For example, the American Lung Association may issue guidelines regarding activity levels that are appropriate for patients who have recently received a lung transplant, that may be provided to HCIM process, for example, in a database form or as fields in an associated record. As such, HCIM process 20 may be configured to provide 204 a prompt to a professional who is providing services to such an individual, to and input the activity level the individual is engaging in (e.g., after asking the patient about them). Other groups that may be considered a clinical authority, for example, include the American Heart Association, the American Cancer Society, the National Committee for Quality Assurance, and so on.

Information relevant to providing 204 a point-of-care prompt (as well as other aspects of HCIM process 20) may be drawn from journals, websites, publications, interviews, and other types of information dissemination by such clinical authorities. In certain embodiments, such information may be automatically collected and categorized by HCIM process 20. In certain embodiments, an administrator or other user may update database (and other) records associated with HCIM process 20 to include relevant clinical authority information, which may then be referenced by HCIM process 20 for relevant use in various ways. In this way (and as further described below), HCIM process 20 may utilize clinical authority information 206 to provide a framework to facilitate efficient and effective provision of health care services. In other words, HCIM process 20 may draw on clinical authority information to determine the appropriate questions to ask of a point-of-care health care provider in order to elicit important condition characteristics.

HCIM process 20 may receive 208 in response to the point-of-care prompt a point-of-care input. In certain embodiments, the response may be known by the provider (or other individual—e.g., the patient) and may be directly input by the provider (or another individual—e.g., the patient) in response to the prompt. In certain embodiments, providing 204 a prompt may remind (or otherwise induce) the provider (or other individual) to direct a particular inquiry (e.g., what are your current activity levels?) to the patient, to conduct a particular evaluation (e.g., assess the number of pain-killer doses remaining in the patient's supply), to conduct a particular test (e.g., measure the patient's blood pressure or take a blood sample), and so on, before the input may be provided to HCIM process 20.

It will be understood that HCIM process 20 may receive 208 a point-of-care input in a variety of ways. For example, in certain embodiments the input may take the form of selecting a particular item or set of items from a list (e.g., a list of all medications currently available to the patient or a list of all recommended activities for a patient with a particular condition). In certain embodiments, the input may take the form of a text entry (e.g., a descriptive entry of the specific symptoms exhibited by a patient). In certain embodiments, the input may take other forms and/or combinations of these and other forms.

The point-of-care input may be associated with a variety of information types. For example, the input may be associated with education material. In providing health care services, education of a patient (e.g., with respect to side effects, characteristics or symptoms of a condition, treatment options, aspects of care for which the patient may take personal responsibility, and so on) may be useful. As such, HCIM process 20 may provide 204 a prompt associated with education material (e.g., Has the patient been made aware of the three non-surgical treatments available for X condition?). Similarly, HCIM process 20 may receive 208 an input associated with educational material.

In certain embodiments, HCIM process 20 may receive 208 input associated with condition assessment 212. A condition assessment may relate to information that is relevant to the assessment of a particular medical condition (e.g., information relating to blood pressure, pain indicators, symptoms of the condition, and so on). By receiving 208 information associated with condition assessment 212, HCIM process 20 may, for example, receive 208 information that may be compared with key indicators drawn from clinical authority information 206 in order to determine whether additional provision 204 of prompts for information are necessary and in order to inform providing guidance and other assistance to the health care provider.

In certain embodiments, HCIM process 20 may receive 208 input associated with co-morbidity information 214. A co-morbidity may include the presence of a secondary condition in addition to (and sometimes related to) a first condition. For example, in a patient being treated for the condition of diabetes, a common co-morbidity is heart disease. Accordingly, it may be effective to address treatment (including diagnosis, and so on) of the patient to both the main condition (e.g., diabetes) and the co-morbidity (e.g., heart disease). Whether a particular co-morbidity is relevant may be determined, for example, based on a patient record, clinical authority information 206, or other information or analysis.

In certain embodiments, HCIM process 20 may receive 208 input associated with diagnosis protocol 216. A diagnosis protocol may be a particular series or set of steps, activities, questions, and so on, that relate to diagnosis of a particular condition, co-morbidity, and so on. As such, in certain embodiments, in order to gather sufficient information regarding a diagnosis of a particular condition and/or in order to guide a provider in the proper execution of a diagnosis protocol, HCIM process 20 may provide 204 a prompt and receive 208 input associated with diagnosis protocol 216. For example, if a particular diagnosis protocol includes first asking about a patient's activity levels, then taking a blood sugar measurement, then a blood pressure measurement, HCIM process 20 may provide 204 a prompt and receive 208 an input associated with each of these steps in the appropriate order (as may be recommended, for example, based on clinical authority information 206).

In certain embodiments, HCIM process 20 may receive 208 input associated with treatment protocol 218. A treatment protocol may be a particular series or set of steps, activities, questions, and so on, that relate to treatment of a particular condition, co-morbidity, and so on. As such, in certain embodiments, in order to gather sufficient information regarding execution of a treatment protocol and/or to guide a provider in the proper execution of a treatment protocol, HCIM process 20 may provide 204 a prompt and receive 208 input associated with treatment protocol 218. For example, if a particular treatment protocol includes administering an oral medication, followed by guiding a patient through certain physical activity, HCIM process 20 may provide 204 a prompt and receive 208 an input associated with each of these steps in the appropriate order (as may be recommended, for example, based on clinical authority information 206).

In certain embodiments, HCIM process 20 may receive 208 input associated with medication information 220. Medication information may be information associated with the use of particular medication including the dosage, frequency of administration, length of treatment, restrictions associated with particular conditions or co-morbidities, and so on. Administration of medication and medication regimes may be important to effective provision of health care services. As such, HCIM process 20 may receive 208 input associated with medication information 220.

In certain embodiments, HCIM process 20 may receive 208 input associated with clinical order information 222. A clinical order may be an order or direction to execute a particular clinical task, such as a diagnosis protocol, a treatment protocol, and so on, and may include various levels of detail regarding certain aspects of such a task. A clinical order may, for example, provide a framework for a course of diagnosis or treatment of a particular patient condition or co-morbidity and as such may be relevant to providing guidance and other assistance to health care providers. As such, HCIM process 20 may receive 208 input associated with clinical order information 220.

In certain embodiments, HCIM process 20 may receive 208 input associated with visit order information 224. A visit order may be, for example, an order or direction to execute a visit to a patient (or facility) on a particular date, at a particular time, for a particular duration, and so on. As such, a visit order may be relevant to provision of health care services. Accordingly, HCIM process 20 may receive 208 input associated with visit order information 224.

In certain embodiments, HCIM process 20 may receive 208 input associated with care planning information 226. Care planning information may include a variety of types of information associated with the historical, present or future provision of medical services to a patient. For example, care planning information may include patient preferences, doctor notes, condition information, treatment information, financial resource information, and so on. In certain embodiments, care planning information may include patient treatment course information (i.e., information relating to the historical course of treatment of a patient) such as the progression of the patient's health with respect to a particular condition or indicator, the patient's compliance with various treatment (e.g., mediation or physical therapy) regimens, and so on.

In certain embodiments, HCIM process 20 may receive 208 input associated with patient resource information 228. Patient resource information may relate to various resources that are available to a patient. For example, patient resource information may include the information that a patient has a blood sugar monitor and blood pressure monitor available at her home, but does not have a scale or pulse monitor. Because the resources available to a patient may be relevant to providing medical services, including, for example, with regard to enlisting the patient to self-administer various protocols or procedures, HCIM process 20 may receive 208 input associated with patient resource information 226.

It will be understood that, as with receiving 208 a point-of-care input, providing 204 a point-of-care prompt may also be associated with education material 210, condition assessment 212, co-morbidity information 214, diagnosis protocol 216, treatment protocol 218, medication information 220, clinical order information 222, visit order information 224, care planning information 226, and/or patient resource information 228. For example, HCIM process 20 may determine an appropriate prompt to provide 204 based upon education material 210, condition assessment 212, co-morbidity information 214, diagnosis protocol 216, treatment protocol 218, medication information 220, clinical order information 222, visit order information 224, care planning information 226, and/or patient resource information 228.

It will be understood that information associated with education material 210, condition assessment 212, co-morbidity information 214, diagnosis protocol 216, treatment protocol 218, medication information 220, clinical order information 222, visit order information 224, care planning information 226, and/or patient resource information 228 may be historical information, information relating to current or ongoing treatment, diagnosis and so on, and/or information relating to planned, forecast or recommended future treatment, diagnosis, and so on.

In order to facilitate effective provision of medical services, education material 210, condition assessment 212, co-morbidity information 214, diagnosis protocol 216, treatment protocol 218, medication information 220, clinical order information 222, visit order information 224, care planning information 226, and/or patient resource information 228 may be combined with or referenced against clinical authority information 206 by HCIM process 20. For example, HCIM process 20 may provide 204 a relevant prompt based on information drawn from clinical authority information 206 regarding a particular condition that is known to be associated with the patient based on clinical order information 224, condition assessment information 212, or care planning information 226, or may analyze the relevance, responsiveness, appropriate follow up to, or other characteristics of a received 208 input based on clinical authority information 206. For example, based on clinical authority information 206 and condition assessment information 212, HCIM process 20 may determine that a patient currently being treated is diabetic and that a common co-morbidity for diabetics is heart disease. Accordingly, HCIM process 20 may provide 204 a prompt for input for that patient relating to heart disease.

HCIM process 20 may provide 209 treatment information. Treatment information may be information relating to a particular course of treatment (e.g., medication, physical therapy, recommended diagnoses, frequency of visits, and so on) and may include recommendations, reminders, educational information, other guidance information, and so on. By providing 209 treatment information, HCIM process 20 may provide guidance, recommendations, or other assistance to a health care provider in order, for example, to ensure that a patient receives appropriate care for her condition. For example, based upon receiving 208 various point-of-care inputs, analyzing a patient record, assessing clinical authority information 206, and so on, HCIM process 20 may determine that a patient is being (or should be) treated for a particular condition in a particular way, that a patient is being (or should be) subjected to a particular diagnosis protocol, that a patient is being (or should be) provided with certain education materials, and so on. As such, in certain embodiments, HCIM process 20 may provide 209 treatment information addressed to treatment of the particular condition in the particular way, executing the particular diagnosis protocol, providing the education materials, and so on.

In order to maximize the relevance of the provided 209 treatment information for a particular patient, particular condition, particular health care visit, particular provider, and so on, HCIM process 20 may provide 209 treatment information based upon one or more received 208 point-of-care input. Further, in order to provide effective health care service assistance, HCIM process 20 may provide 209 treatment information associated with clinical authority information 206. In certain embodiments, HCIM process 20 may additionally/alternatively provide 209 treatment information including or associated with education material 210, condition assessment 212, co-morbidity information 214, diagnosis protocol 216, treatment protocol 218, medication information 220, clinical order information 222, visit order information 224, care planning information 226, and/or patient resource information 228, alone or in combination with each other and/or clinical authority information 206 or other information.

In certain embodiments, in order to provide guidance that is relevant to treatment, diagnosis and so on that a patient may have already received (e.g., to continue an ongoing course of treatment, follow up on a previous diagnosis, and so on), HCIM process 20 may identify 228 historical diagnosis information or historical treatment information associated with a particular patient. HCIM process 20 may identify 228 historical diagnosis or treatment information, for example, based on clinical order information 222, visit order information 224, condition assessment information 212, care planning information 226, a patient record, and so on. HCIM process 20 may, in certain embodiments, provide 209 treatment information based upon such historical diagnosis information and/or such historical treatment information.

It will be understood, based on the discussion above (and as elaborated in the discussion below), that HCIM process 20 may facilitate the compilation of (and/or access to) a complete record of relevant patient information at the point-of-care and may utilize such a record in combination with, for example, clinical authority information 206, in order to provide guidance, recommendations or other assistance to a health care provider that is providing services to the patient at the point-of-care.

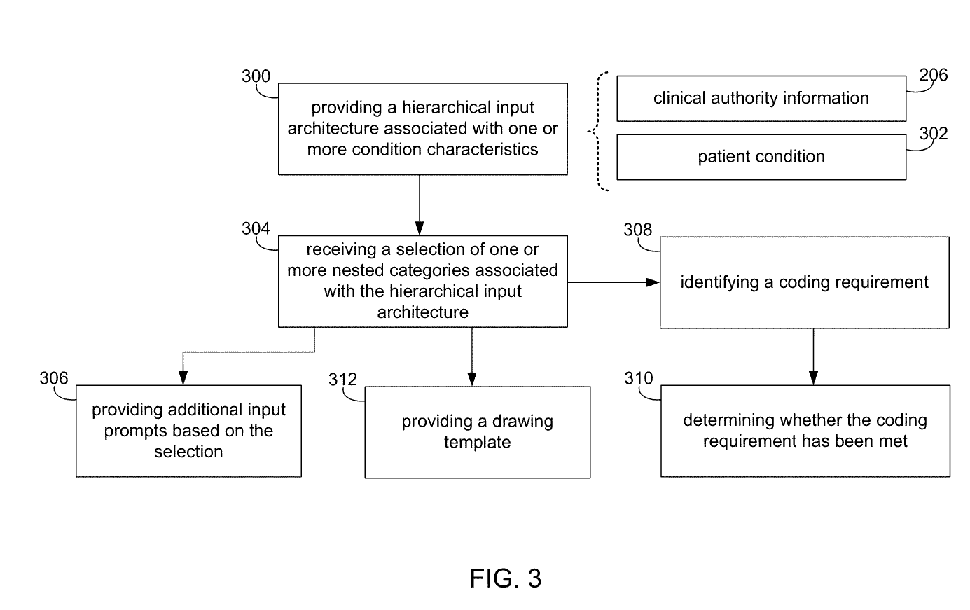

Referring now also to FIG. 3, HCIM process 20 may provide 300 a hierarchical input architecture associated with one or more condition characteristics. As noted above, to facilitate providing guidance to a health care worker, HCIM process may provide 204 a prompt for an input relating to various types of health care information. In certain embodiments, such a prompt may be directed to appropriately specifying a particular medical condition for a particular patient. However, certain medical conditions (e.g., “macro” conditions) may include a variety of related but distinct sub-conditions. For example, the condition of diabetes may refer generally to a condition involving abnormalities associated with insulin. However, within the macro condition category of diabetes there may be a variety of sub-categories relating to particular manifestations, symptoms and so on of diabetes and which may be characterized by distinct (and even opposite) indications. Due to the number of potential sub-categories of macro conditions, it may sometimes be difficult, particularly for health care providers with lower-level medical training, to recognize, diagnose, treat, or evaluate a specific manifestation of a condition in a particular patient. However, such specific manifestations may sometimes be characterized (e.g., based on clinical authority information 206) as sub-categories of a larger condition category (i.e., a macro category). Accordingly, it may be useful to the accurate identification/treatment/etc. of a patient's condition(s) (and/or co-morbidities) for HCIM process 20 to provide 300 a hierarchical input architecture relating to patient condition characteristics. Further, because various provider input may be useful to identifying specific condition characteristics (or sub-conditions), HCIM process may provide 204 a prompt for point-of-care inputs including providing 300 a hierarchical input architecture.

For example, HCIM process may provide 300 a first hierarchy level in which a provider is prompted to specify a particular aspect of a patient's condition 302 (or answer a particular question directed to providing such information) relating, for example, to a macro condition. For example, HCIM process may provide 300 a list from which a provider may select a particular main characteristic of a patient's condition. When HCIM process 20 receives 304 selection of such main characteristic, this may trigger (based, for example, on other input from the provider, clinical authority information 206, and so on) HCIM process 20 to provide 300 a sub-list of possible sub-characteristics of the patient's condition, stemming from the first-selected main characteristic. This may continue, for example, until HCIM process 20 has received 302 a complete (or otherwise adequate) specification of condition characteristics (as determined, for example, based upon patient condition information 302, clinical authority information 206, and so on).

HCIM process 20 may further provide 306 one or more additional point-of-care input prompts based upon, at least in part, receiving 304 the selection of a nested category, wherein the one or more additional input prompts may be associated with the one or more condition characteristics. For example, whereas a particular inquiry, diagnosis, treatment, and so on may not be relevant to all individuals with a particular macro condition, such an inquiry, diagnosis, treatment, and so on may be relevant to individuals exhibiting a particular condition characteristic existing as a sub-category of the relevant macro condition. As such, in certain embodiments, HCIM process 20 may request information from the provider (or other individual) regarding such sub-category condition characteristic only after receiving 304 a selection of that sub-category condition characteristic. In this way, HCIM process 20 may provide a fine-grain selection of protocols (and other health care information) to match the specific aspects of a patient's chronic and/or acute conditions.

HCIM process 20 may identify 308 a coding requirement based upon receiving 304 the selection of the one or more nested categories. Coding may refer to the specific designation of a condition (and/or diagnosis, treatment, and so on) including any relevant details (e.g., any relevant condition characteristics), which may be important to provision of services, recordkeeping, billing, and so on. In order for a provider to validly code certain conditions (or condition characteristics), standard protocols may require the provider to validate the coding with a particular diagnostic test, follow up on the coding with a particular treatment measure, or otherwise execute a particular medical task. (Such protocols may be drawn, for example, from clinical authority information 206 or other sources.) In order to ensure that such protocols are properly followed, and therefore, in order to ensure that providers validly code certain conditions (or condition characteristics), HCIM process 20 may identify 308 a coding requirement and may determine 310 whether the coding requirement has been met.

For example, in certain embodiments, after receiving 304 a selection of a particular condition characteristic for coding, HCIM process 20 may identify 308 an associated coding requirement and may provide 204 a prompt to the provider for input relevant in order to determine 310 whether the coding requirement has been met. For example, if a health care provider selects a condition characteristic that may be validly coded only based on a particular blood test, HCIM process 20 may identify 308 that the blood test is necessary for valid coding (e.g., by referencing clinical authority information 206), may provide 204 a prompt relating to whether the blood test was conducted and/or whether the provider has the results of the test, and, based on the response to the prompt, may determine 310 whether the coding requirement was met. For example, if a nurse codes renal complications as a condition characteristic of a patient with a diabetes condition, but does not provide the necessary documentation, HCIM process 20 may recognize the deficiency and may prompt the nurse to obtain the necessary documentation as part of the current treatment (rather than, for example, returning at a later time).

In certain embodiments, HCIM process 20 may provide 312 a drawing template based upon, at least in part, the selection of a particular condition characteristic (e.g., based on receiving 304 a selection of a nested category associated with a hierarchical input architecture). Because certain condition characteristics (e.g., skin lesions) may be more effectively assessed/treated/etc. if a visual representation of the condition characteristic is included in a patient record, it may be useful to provide drawings of certain aspects of certain condition characteristics. To facilitate providing these drawings HCIM process 20 may, for example, provide a drawing template that is customized to a particular selected condition characteristic. For example, if a provider indicates that one condition characteristic of a patient is lesions to the lower extremities, HCIM process 20 may automatically provide a drawing template of a generic lower extremity on which the provider can specifically indicate various aspects of the lesions (e.g., size, shape, and so on).

HCIM process 20 may provide 312 a drawing template based on receiving 304 a selection of a nested category. It will be understood that HCIM process 20 may additionally/alternatively provide 312 a drawing template based on a variety of other inputs or factors. For example, input or determination of a particular condition, condition characteristic or co-morbidity at various points in HCIM process 20 may trigger HCIM process 20 to provide 312 a drawing template (based, for example, on guidance from clinical authority information 206).

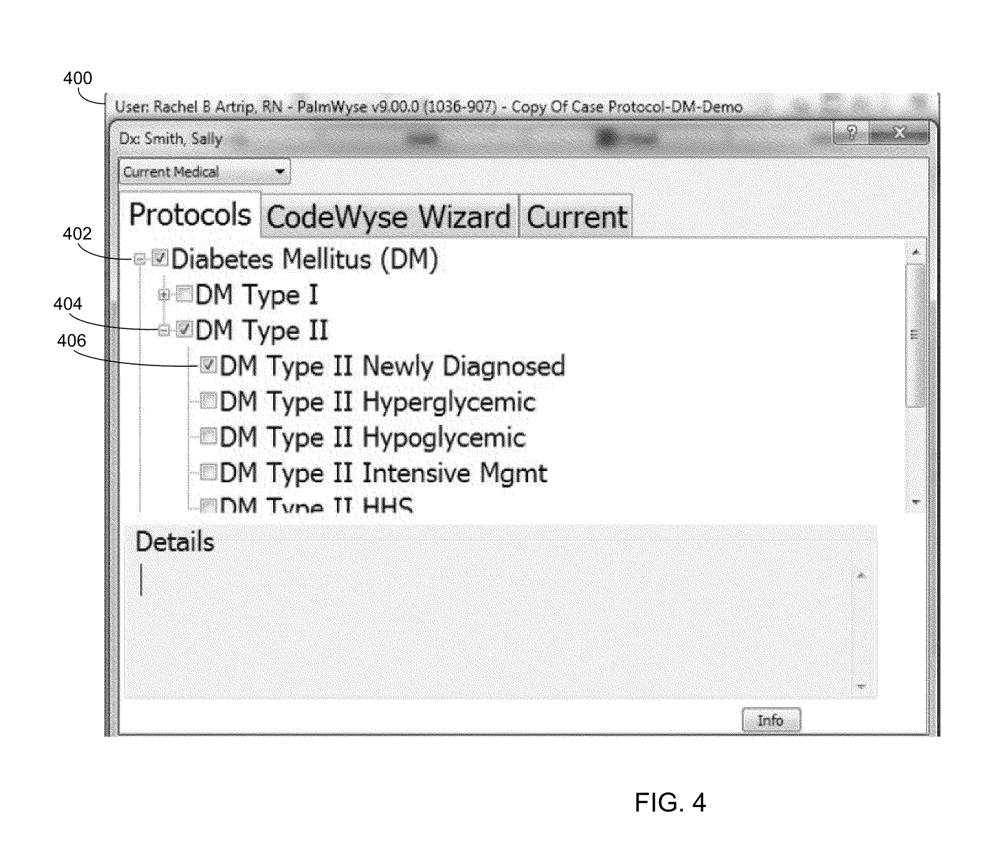

Referring now also for FIG. 4, a hierarchical input architecture may be seen. For example, in user interface 400, macro category 402 of Diabetes Mellitus may be provided 300. Receiving 304 a selection of macro category 402 may prompt the availability of sub-categories such as sub-category 404 DM Type II (i.e., type two diabetes). Receiving 304 a selection of sub-category 404 may prompt the availability of further sub-categories, including sub-category 406 DM Type II Newly Diagnosed. It will be understood that a provider may, in certain embodiments, select multiple macro and/or sub-categories or may be prevented from selecting multiple macro and/or sub-categories depending on whether such selections are consistent with, e.g., clinical authority information 206.

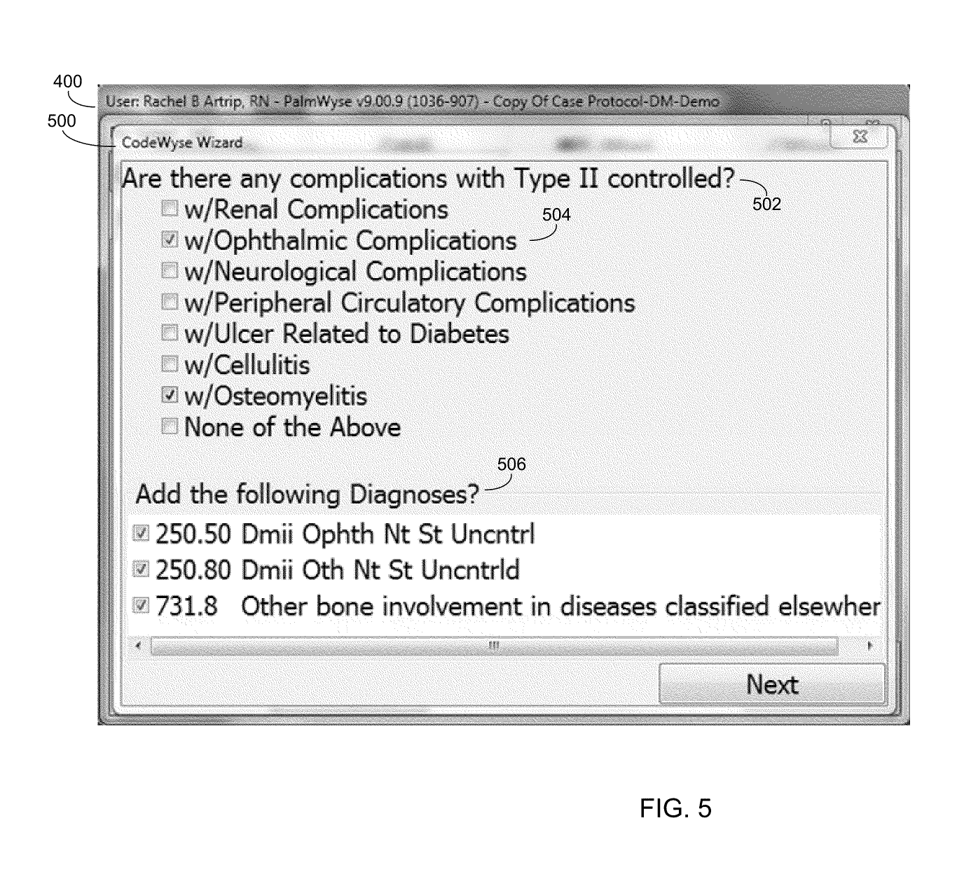

Referring now also to FIG. 5, based on selection by the provider, for example, of Type II controlled as a condition characteristic (as indicated by title/question 502), HCIM process 20 may provide 306, in window 500, additional prompts for input related to the selected condition characteristic. For example, whether or not a patient with Type II controlled DM has opthalmic complications 504 may be relevant to proper diagnosis and treatment of the patient's condition(s). As such, HCIM process 20 may provide 306 a prompt regarding this condition characteristic, based on which the provider (or other individual) may indicate additional information.

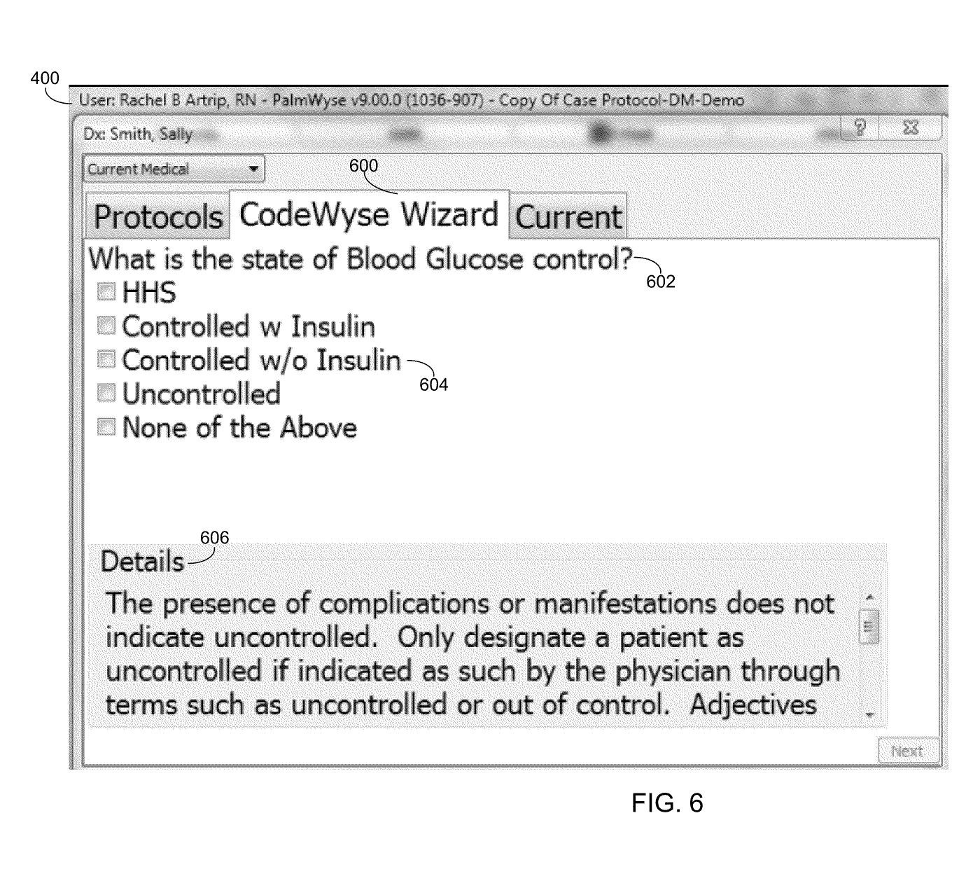

Referring now also to FIG. 6, HCIM process 20 may provide, for example, in tab 600, additional prompts for input related to selected condition characteristics (e.g., question 602 with various answer options including, e.g., answer option 604). Further, HCIM process 20, based, for example, on clinical authority information 206, may provide explanatory details 606 to assist a provider in responding to the additional prompts appropriately (e.g., in selecting an appropriate answer option).

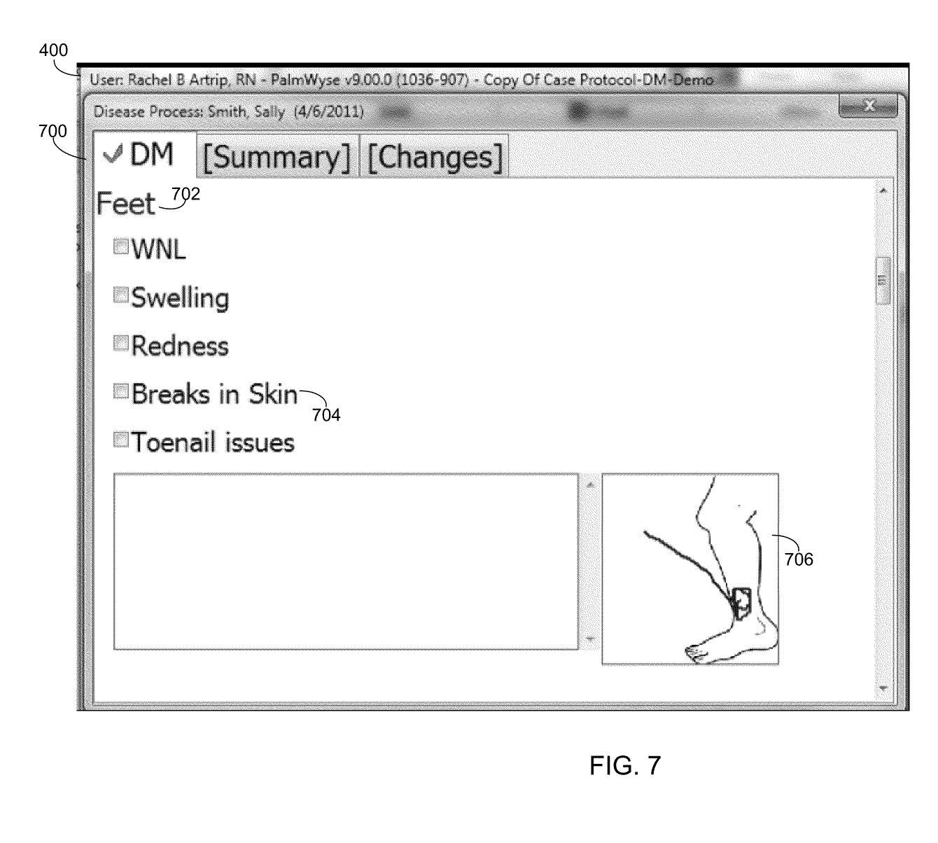

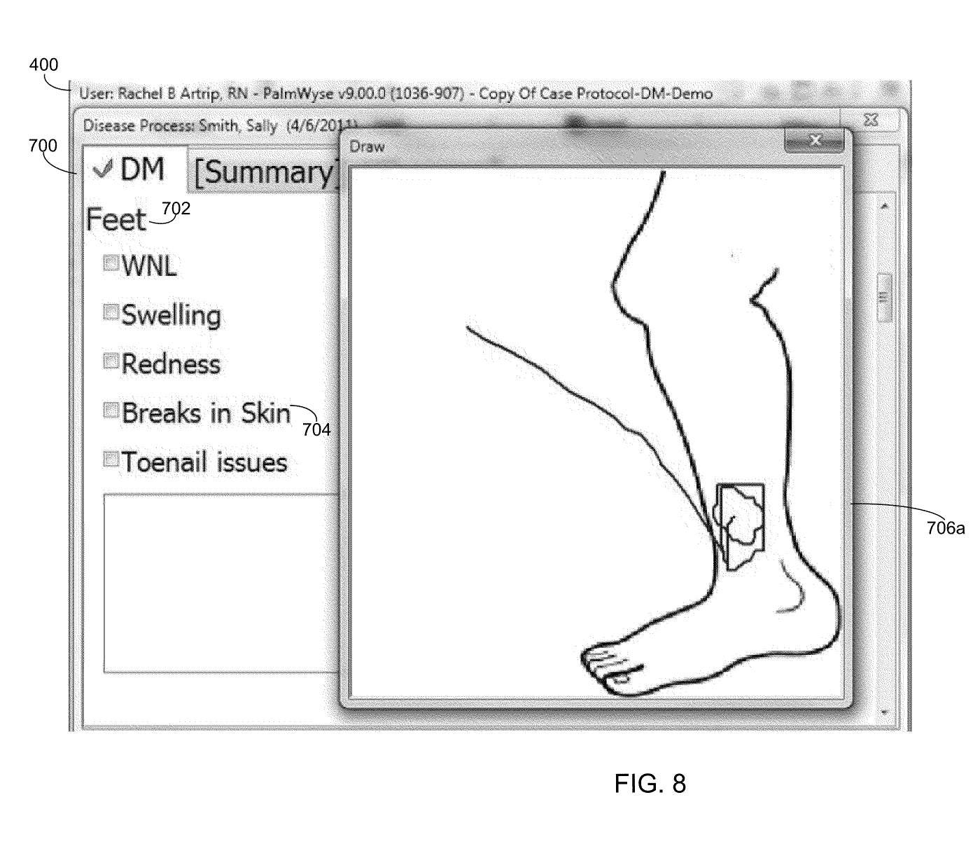

Referring now also to FIGS. 7 and 8, HCIM process may provide 312 drawing templates based on, for example, receiving 304 from a provider a selection of particular condition characteristics. For example, window 700 may include condition characteristic 702 regarding foot problems, stemming from the macro condition of diabetes. Such foot problem characteristic 702 may include further sub-characteristics including, for example, breaks in skin 704. If a provider (or other individual) selects breaks in skin sub-characteristic 704, HCIM process 20 may provide 312 expansion 706a of drawing template 706, on which a provider (or other individual) may provide a visual depiction of characteristics of breaks in skin sub-characteristics 704 that may then be associated with the patient record.

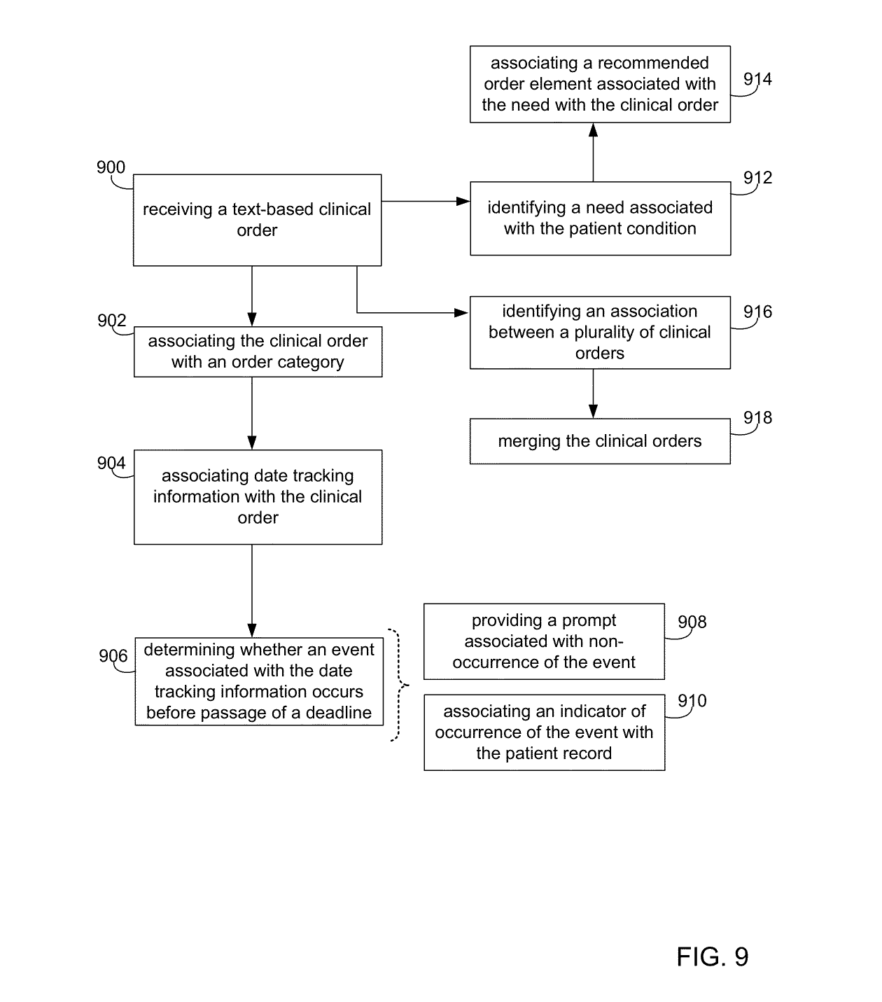

Referring now also to FIG. 9, HCIM process 20 may include receiving 900 a clinical order including a text-based clinical order. As noted above, a clinical order may be an order or direction to execute a particular clinical task, such as a diagnosis protocol, a treatment protocol, and so on, and may include various levels of detail regarding certain aspects of such a task. A text-based clinical order may be a clinical order that is written in customizable text form by a provider (or other individual). A provider may enter a text-based clinical order into an input window (or other area) associated with HCIM process 20, which may be linked in certain embodiments to various conditions, condition characteristics, treatment plans, and so on.

Text-based clinical orders may include detailed information, but, because they may not always be written using standardized descriptions they may be difficult to interpret and/or categorize by individuals other than the author of the order. Accordingly, in certain embodiments, HCIM process 20 may associate 902 the clinical order with an order category. For example HCIM process 20 may, upon receiving 900 a text-based clinical order, prompt the author of the order to assign a category to the order out of a predetermined set of clinical order categories. Such sets may be determined, based, for example, on clinical authority information 206, customized information associated with a particular provider organization, or other information. For example, a provider may submit a particular clinical order regarding a diabetic patient to HCIM process 20 and may categorize (before or after submission) the order as, for example, related to exercise, education, medication, diagnosis, and so on. In certain embodiments, a category may be additionally/alternatively linked to a particular condition or condition characteristic (e.g., foot care for a diabetic patient). Such linking may, for example, facilitate more efficient tracking of the efficacy of care with respect to large cohorts of patients. For example, rather than read each text-based order associated with each of a care agency's diabetic patients in order to assess whether foot issues are being appropriately addressed, an administrator of a care agency may utilize categories (e.g., through HCIM process 20) to isolate all clinical orders relating to diabetic foot care and determine, for example, whether (a) each diabetic patient had such a clinical order and (b) whether such clinical orders were being fulfilled for each patient.

In certain embodiments, a clinical order may be associated 902 with a variety of categories. For example, HCIM process 20 may facilitate a provider selection categories of “diabetes,” “medication administration,” and “foot care” for a particular clinical order.

In certain embodiments, an order category may include date information. For example, certain categories may specify that a clinical order requires follow-up on a certain date or that a clinical order sets a treatment target (e.g., weight reduction or increased joint mobility) for a certain date. In such a case, for example, HCIM process 20 may associated 904 date tracking information (e.g., a particular target/goal and/or a particular deadline) with such a clinical order. Further, HCIM process 20 may determine 906 whether an event associated with the date tracking information (e.g., as specified by a clinical order category or other HCIM process 20 data point) has occurred by the time that deadline arrives. For example, based on an input from a provider, HCIM process 20 may determine 906 that a particular goal was (or was not) met by a particular deadline. If the event has not occurred (e.g., weight has not been suitably reduced, as determined, for example, by receiving 208 a point-of-care input), HCIM process 20 may provide 908 a prompt associated with the non-occurrence. If the event has occurred (e.g., joint mobility has been suitably increased, as determined, for example, by receiving 208 a point-of-care input), HCIM process 20 may associated 910 an indicator of the occurrence with the patient record. For example, HCIM process 20 may associate 910 an indicator of satisfactory follow-through with a particular clinical order.

HCIM process 20 may identify 912 a need associated with a patient condition. HCIM process 20, in certain embodiments may identify 912 the need based, for example, upon coding of a particular condition or condition characteristic and clinical authority information 206. For example, clinical authority information 206 may indicate that a particular treatment measure is highly recommended for a particular condition. HCIM process 20 may therefore, based on a patient receiving a coding associated with that condition, identify 912 a need for that treatment measure.

Based on identifying 912 a need, HCIM process 20 may, in certain embodiments, associate 914 with a clinical order a recommended order element associated with the need. For example, if clinical authority information 206 indicates that particular type of foot treatment is highly recommended for diabetic patients exhibiting a particular condition characteristic and the patient being treated exhibits that condition characteristic, HCIM process 20 may associate 914 with a clinical order categorized as related to foot treatment a recommendation that execution of the order include the particular foot treatment.

Still referring to FIG. 9, HCIM process 20 may receive 900 a plurality of text-based clinical order and may identify 916 an association between the two or more of the plurality of orders. For example, based on clinical authority information 206, based on similar categories of the orders relating to symptoms, medications, protocols, co-morbidity, and/or based on various other information, HCIM process 20 may identify 916 that two or more clinical orders may be efficiently executed as part of the same protocol/visit/activity. As such, HCIM process 20 may merge 918 the two or more clinical orders together to prompt a provider to execute the clinical orders at the same time. HCIM process 20 may merge 918 clinical orders in a variety of ways. For example, HCIM process 20 may actually combine the text of clinical orders, may place the orders in close proximity on a display, may associated a note with each of the orders referring to the fact that they have been merged 918, and so on. This may, for example, ensure that care is provided efficiently and that co-morbidities are handled appropriately.

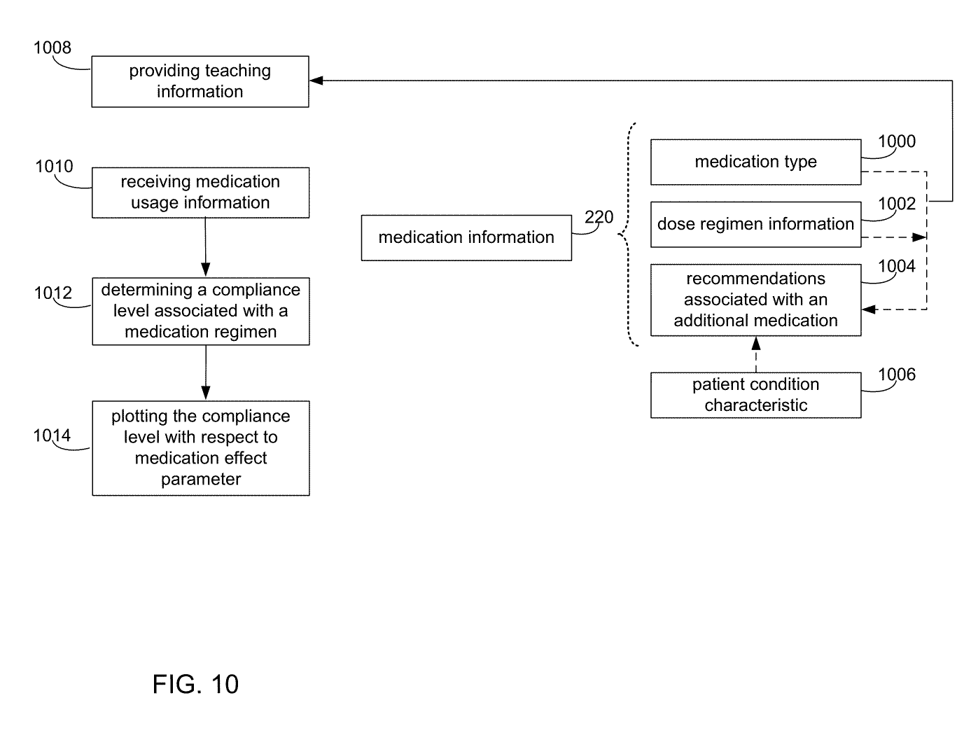

Referring now also to FIG. 10, medication information 220 (as also described above) may include medication type 1000. For example, HCIM process 20 may utilize medication information 220 that includes information associated with the brand of a medication, the chemical type of a medication, the method of administration of a medication, and so on. Similarly, medication information 220 may include medication dose regimen information 1002. For example, HCIM process 20 may utilize medication information 220 that includes information associated with the volume or weight of a dose of medication, the frequency of dosage of a medication, the length of a medication's effects, the amount of time over which a medication is to be administered, the number of allowable refills of a medication prescription, the project refill dates of a medication, and so on. As such, HCIM process 20 may, for example, provide 204 a prompt for a provider to enter medication type 1000, dose regimen information 1002, and so on or may derive medication type 1000 and dose regimen information 1002 from a patient record or other information source.

In certain embodiments, providing 209 treatment information may include providing 204 recommendations 1004 associated with an additional medication, wherein the recommendations 1004 may be associated with medication type 1000, medication dose regimen information 1002, and/or a characteristic 1006 associated with the patient condition. For example, based on the collection and analysis of various patient condition information, clinical authority information 206, and other factors, HCIM process 20 may determine that a particular medication type 1000 or medication dose regimen may be appropriate to treat a particular patient condition characteristic 1006. Accordingly, HCIM process 20 may recommend 1004 a particular medication and/or dose regimen. For example, based on receiving 208 an input related to prescribing a narcotic painkiller to a patient, HCIM process 20 may determine, based on clinical authority information 206, that a laxative should also be prescribed to avoid complications. If, for example, HCIM process 20 determines, based on the patient record or other information, that no laxative has been prescribed, HCIM process 20 may accordingly recommend 1004 such a prescription.

HCIM process 20 may additionally/alternatively provide 1008 teaching information associated with medication type 1000, dose regimen information 1002, recommendations 1004 regarding medication and/or other information. For example, based on clinical authority information 206, HCIM process 20 may determine that certain teaching information (e.g., descriptions of side effects, discussion of proper ingestion techniques, and so on) may be appropriate for a particular medication. Accordingly, HCIM process 20 may provide 1008 such teaching information based on determining (e.g., from the patient record) that such medication has been prescribed and that such teaching information has not yet been provided. In certain embodiments, teaching information (and other information) may be provided 1008 in a customized language.

In certain embodiments, HCIM process 20 may receive 1010 medication usage information. For example, HCIM process 20 may receive 1010 information relating to the projected refill date of a prescription, the actual refill date of a prescription, a patient's current supply of medication, and so on. From this information, HCIM process 20 may, for example, determine 1012 a compliance level associated with a medication regimen. For example, based on dose regimen information 1002, HCIM process 20 may determine that a patient should take 2 pills a day of a particular medication. Further, HCIM process 20 may receive 1010 information from the patient record that the patient started with a 30-day supply of pills (i.e., 60 pills), and that next projected refill is in 12 days, but that (based on a manual count by the provider) the patient has 36 pills remaining. Accordingly, HCIM process 20 may determine 1012 that the patient has complied with the two-pill-a-day regimen, on average, on only 67% of the days (i.e., that the patient has a compliance level of 67%). This may prompt HCIM process 20, for example, to provide 1008 teaching information, to associate a reminder with a clinical order regarding the patient's low compliance level, or to take another appropriate action.

To facilitate diagnoses of various issues by a provider (or other individual), in certain embodiments, HCIM process 20 may plot 1014 the determined 1012 compliance level with respect to one or more medication effect parameters. This may assist a provider in determining whether, for example, negative effects on a patient's condition characteristics should be attributed to non-compliance with a drug regimen (or whether positive effects should be attributed to rigorous compliance), and so on. For example, based on clinical authority information 206, HCIM process 20 may identify that blood sugar levels are a key medication effect parameter associated with an insulin drug. Accordingly, HCIM process 20 may plot historical and/or current compliance levels for a patient against blood sugar levels for that patient. If the patient exhibits, for example, low compliance levels for the drug regimen, but the blood sugar levels are normal (or abnormal blood sugar does not correlate with the low compliance levels), the provider may be able to make a more informed assessment of the efficacy of the drug. Similarly, if the patient exhibits, for example, abnormal blood sugar, a plot of blood sugar with respect to high compliance levels may help the provider determine that a factor other than low compliance (e.g., lifestyle choices) may be to blame for the identified blood sugar issues.

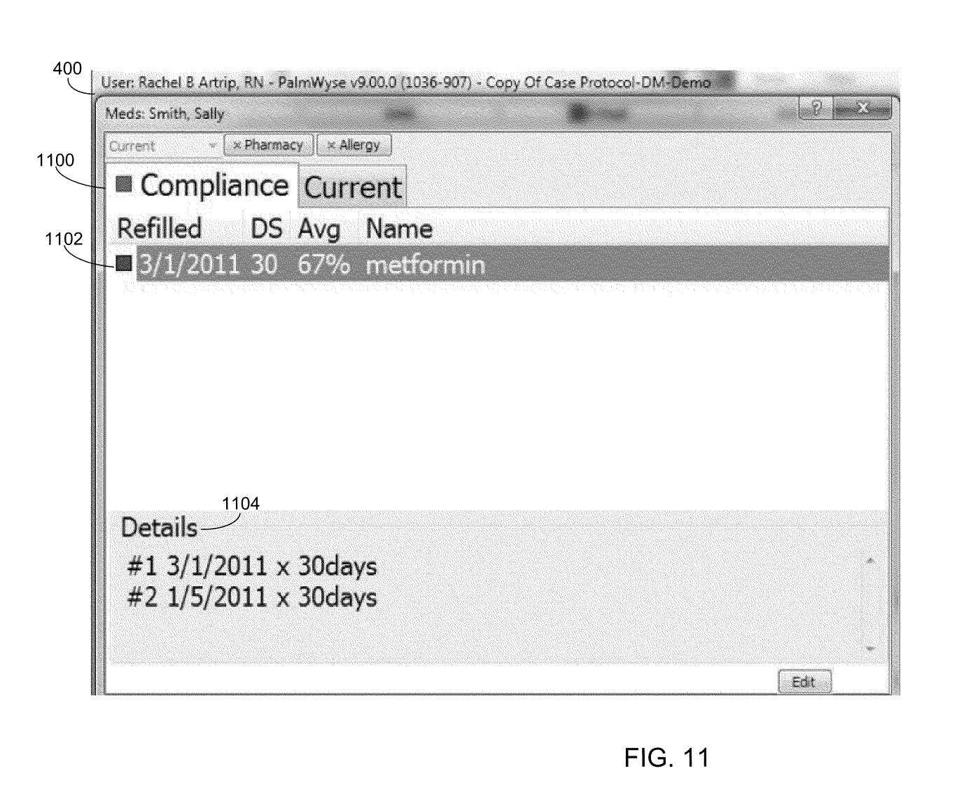

Referring now also to FIG. 11, in interface 400, window 1100 may indicate that a patient has exhibited compliance 1102 of only 67% with respect to the medication metformin. HCIM process 20 may determine 1012 this level, for example, based on assessment of details 1104 including the projected time between refills (30 days) and the actual time between refills (January 5 through March 1).

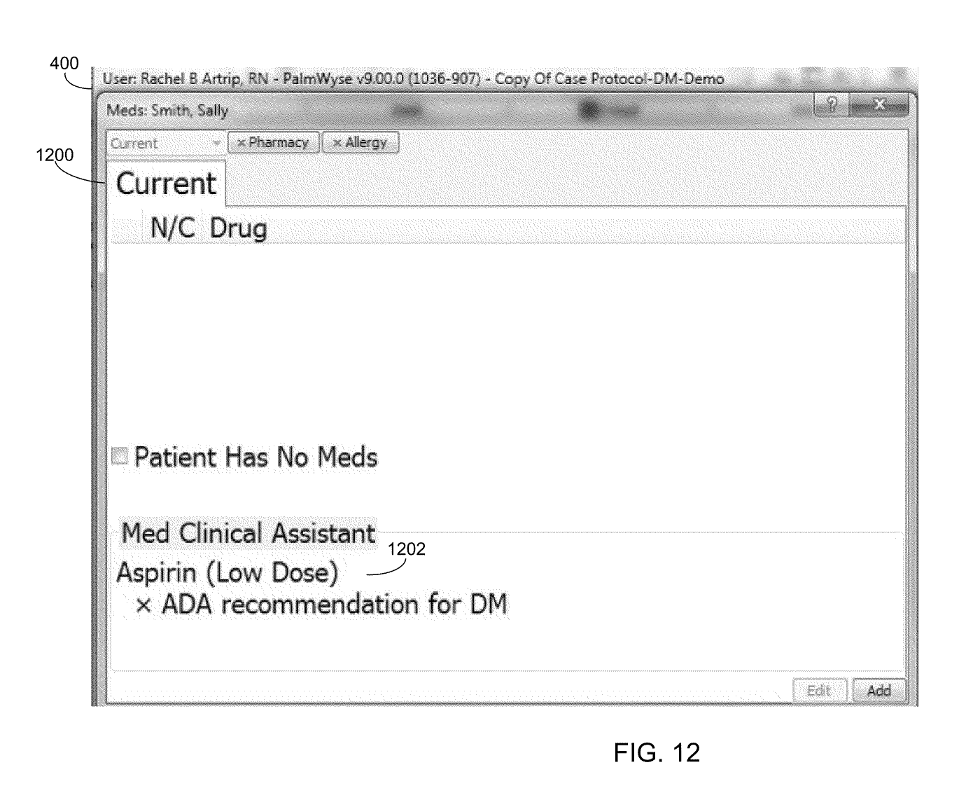

Referring now also to FIG. 12, based on the determination that a patient suffers from a diabetic condition, HCIM process 20 may recommend 1004 that the patient take a low dose of aspirin (based, for example, on clinical authority information 206). This may be indicated, for example, in window 1200 by dose recommendation 1202.

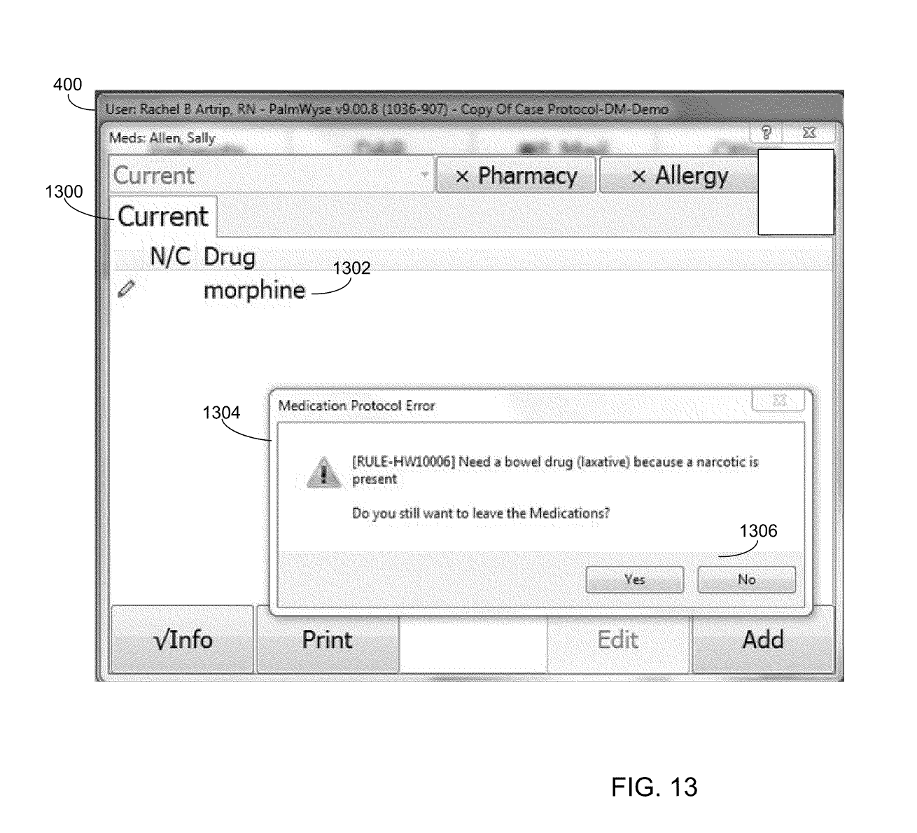

Referring no also to FIG. 13, based on the determination that a patient has been prescribed morphine 1302, as indicated in window 1300, and based, for example, on clinical authority information 206, HCIM process 20 may recommend 1004, in pop-up window 1304 that a laxative 1102 be prescribed. To further facilitate provision of care by the provider, HCIM process 20 may in this (and other cases) provide an option to automatically adjust medication (and other) information based on its recommendations and/or automatically move among interface modules within interface 400. For example, in window 1304, because HCIM process 20 has determined that no laxative has been prescribed, it may present a provider with a prompt that may allow the provider to select via input buttons 1306, whether to stay in this particular interface module (e.g., so that the provider can add a laxative prescription) or to exit the interface module without prescribing a laxative.

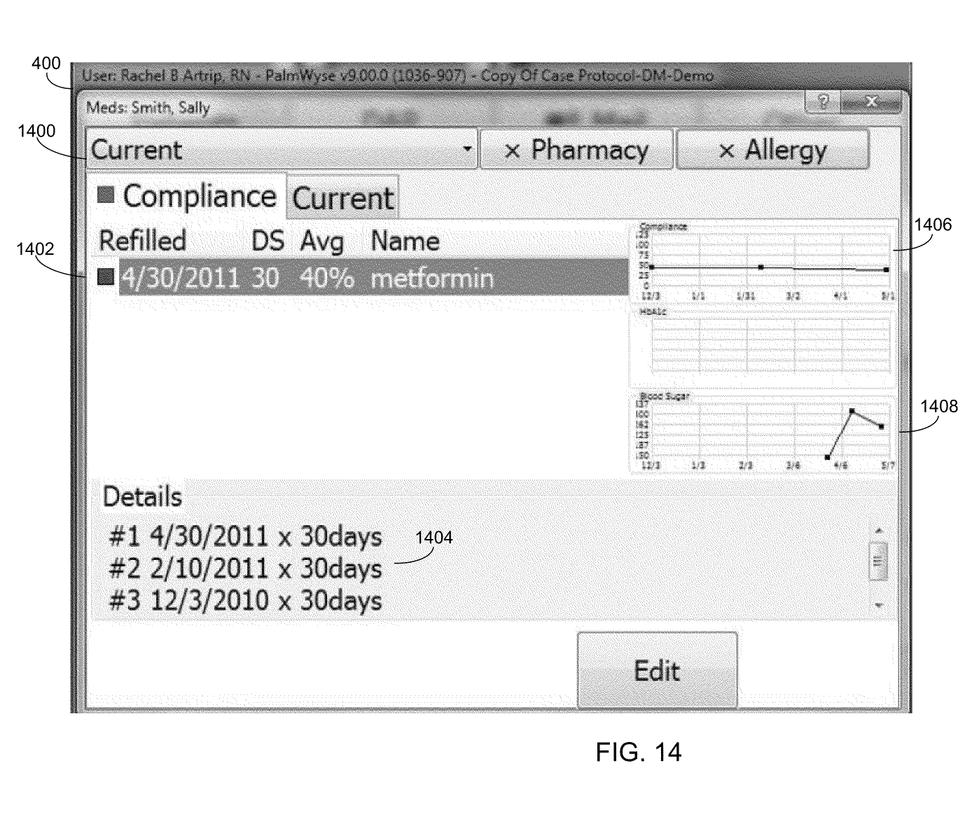

Referring now also to FIG. 14, HCIM process 20 may determine 1012 a compliance level of 40% for the drug metformin based on, for example, receiving 1010 dose regimen information 1404. Further, HCIM process 20 may plot 1014 over time this patient's compliance level 1406 against medication effect parameter 1408 (e.g. blood sugar) in order to allow a provider to more easily assess the relationship between the compliance level 1406 and the medication effect parameter 1408.

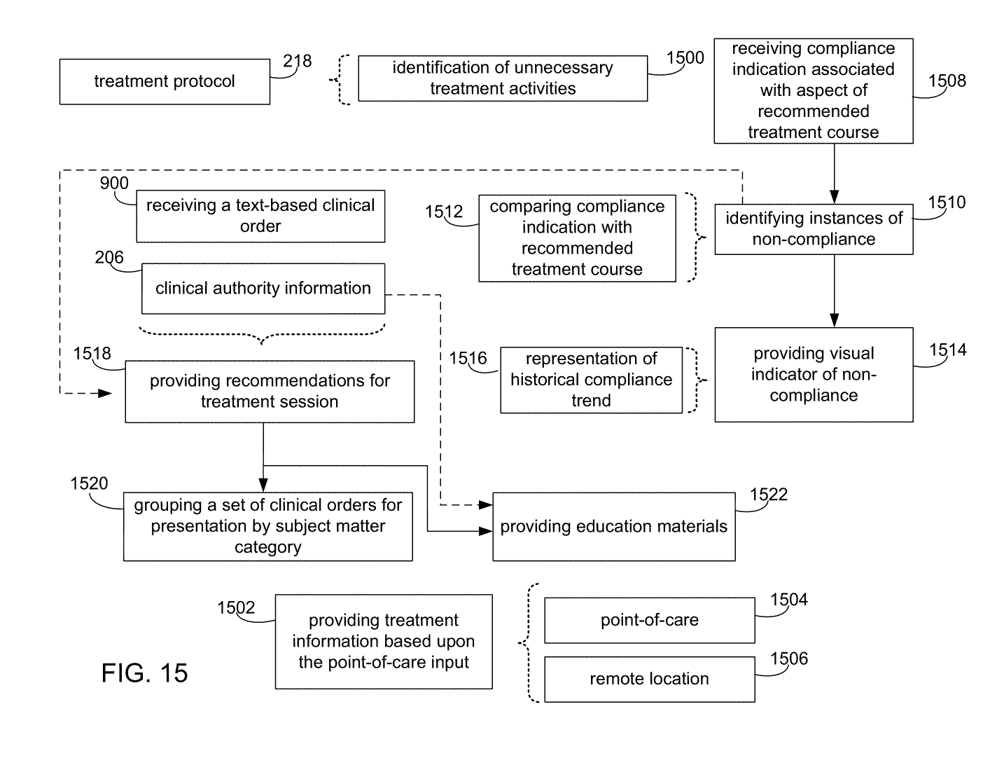

Referring now also to FIG. 15, in certain embodiments, HCIM process 20 may provide 209 treatment information wherein treatment protocol 218 included in the treatment information includes identifications 1500 of unnecessary treatment activities. For example, based on clinical authority information 206 (e.g., indicators for a condition or condition characteristic) and other information in a patient's record (e.g., doctor's notes, clinical orders, and so on), HCIM process may identify necessary and unnecessary actions, diagnoses, treatments, and so on. In certain embodiments, HCIM process 20 may identify that certain unnecessary actions have been associated with a patient record, e.g., may be included in a clinical order (as determined, for example, by clinical order category). Accordingly, in certain embodiments, HCIM process 20 may provide 204 identification 1500 of unnecessary treatment activities in order to guide appropriate actions by the provider.

For example, if the weight of a patient is not relevant to the condition being treated (or to any co-morbidities thereof), HCIM process 20 may identify 1500 that weight need not be measured at visits relating to that condition and relate this information to the provider (or another individual). HCIM process 20 may identify 1500 this unnecessary procedure in a number of ways. For example, HCIM process 20 may inform a provider of any unnecessary (but common) procedures at the start of a visit or may associate a note with a relevant clinical order.

In certain embodiments, HCIM process 20 may provide 209 treatment information at a variety of locations. For example, to better facilitate provision of care by the on-site provider, HCIM process 20 may provide 209 treatment information at point-of-care location 1504. In certain embodiments, in order to facilitate activities of off-site personnel (e.g., a doctor evaluating an on-site visit from her office), HCIM process 20 may provide 209 treatment information to a system located in remote location 1506. This may facilitate the on-site provider providing effective service while also facilitating review by an off-site supervisor of what should have been done by the provider, what was actually done by the provider, and so on.

HCIM process 20 may receive 1508 compliance indications associated with aspects of a recommended treatment course, wherein provided 209 treatment information includes the recommend treatment course. For example HCIM process 20 may receive 1508 from a provider indications of what tasks/actions have been completed from a clinical order, what tasks/actions a patient has completed (e.g., if the patient has self-gathered or self-reported data), and so on. Based on this and other information, HCIM process 20 may identify 1510 instances of non-compliance with the one or more aspects of a recommended treatment course. In certain embodiments HCIM process 20 may identify 1510 instances of non-compliance with a recommended treatment course based upon comparing 1512 the one or more indications of compliance with the recommended treatment course. In certain embodiments, HCIM process 20 may provide 1514 a visual indicator of compliance or non-compliance to assist the provider (and/or patient) in ensuring that uncompleted tasks/goals/etc. are addressed appropriately, wherein the visual indicator includes a representation 1516 of one or more historical compliance trends.

For example, in certain embodiments, HCIM process may provide a color-coded visual indicator to indicate whether or not certain objectives/tasks/etc. have been completed in a satisfactory and/or timely fashion. In certain embodiments, HCIM process 20 may aggregate data over time and may represent that data graphically (or otherwise) to show a patient's/condition's treatment history and thereby facilitate a provider analyzing the progress of a treatment course.

HCIM process 20 may provide 1518 recommendations for activities, protocols, personnel, and other parameters associated with a current or future treatment session. HCIM process 20 may provide 1518 such recommendations based upon a variety of information. For example, HCIM process 20 may provide 1518 recommendations based on clinical authority information 206, identifying 1510 instances of non-compliance, and/or receiving 900 one or more clinical orders. For example, based on medical journals, past diagnoses, planned activities (based on, e.g., clinical orders) and so on, HCIM process 20 may provide 1518 to a provider recommendations regarding what should be happen during a particular health care session including, in certain embodiments, through prompting the provider to provide specific inputs (e.g., in response to questions for the patient or provider provided by HCIM process 20) or take certain actions.

Providing 1518 recommendations may include grouping 1520 a set of clinical orders for presentation by subject matter category. For example, clinical orders may be received 900 in a variety of sequential orders and may, accordingly not be organized, as received 900, for efficient execution. Based on associating 902 categories with the clinical orders, however, HCIM process 20 may group 1520 the orders for effective execution. For example, HCIM process 20 may group 1520 all education-related clinical orders for presentation to the provider. In this way, the provider can easily see the education-related recommendations/tasks for a particular session and may accordingly organize her time efficiently.

As also noted above, grouping 1520 orders by category and identifying 1510 instances of non-compliance may facilitate a health care agency managing of patients with different clinical orders using the same methodology. For example, foot examinations may be necessary for diabetes patient, but the specific examination (and the accompanying clinical order text) may vary from patient to patient. Through HCIM process 20 grouping 1520 the orders by the overarching category, an administrator may, for example, focus her inquiry to easily verify what percentage of “foot-related” order were fulfilled across a patient cohort, without having to read every text-based clinical order. This may, accordingly, facilitate agencies (and others) verifying that care for patients with particular conditions is following appropriate generalized guidelines (e.g., as provided in clinical authority information 206) without needing to manually parse individual order text

In certain embodiments, providing 1518 recommendations may include providing 1522 relevant education materials, based upon the clinical authority information 206, patient condition information, and/or other patient record information. For example, HCIM process 20 may provide 1522 specific education-related materials based on a specific diagnosis, progress, session guideline and recommendations and/or other indicators to facilitate effective education of patient.

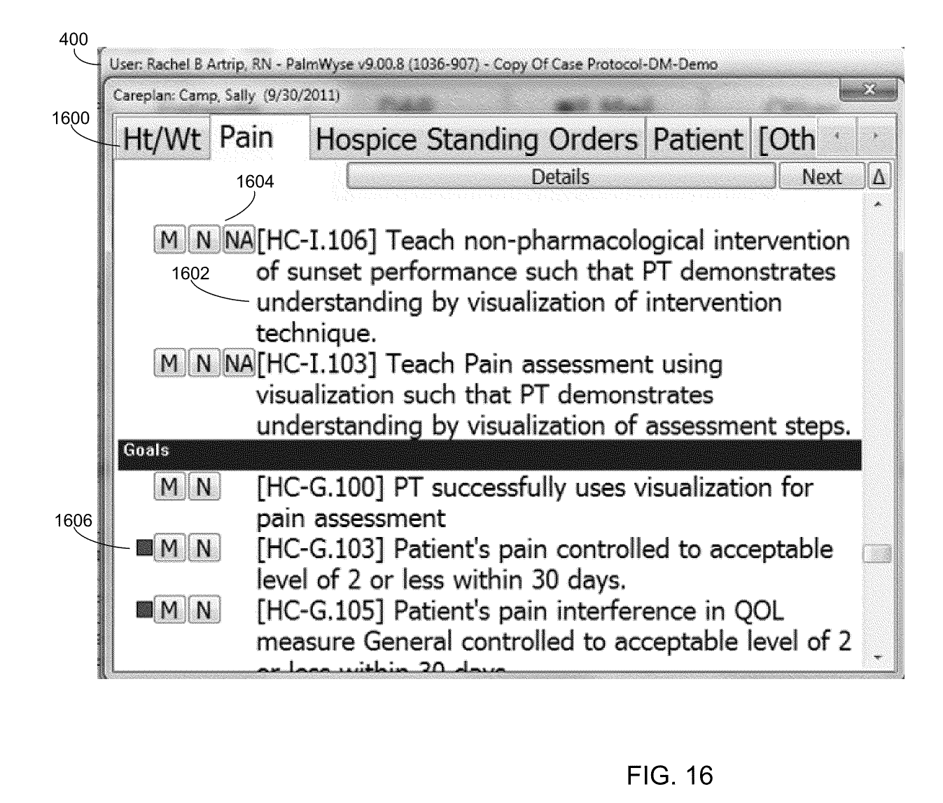

Referring now also to FIG. 16. Within window 1600, HCIM process 20 may receive 1508 compliance indications based on compliance indicator buttons associated with particular clinical orders. For example, clinical order 1602, associated with a particular treatment session, may include teaching the patient certain information. Based on the actual events of the session, the provider may use buttons 1604 to indicate that the recommendation was (M)et, (N)ot Met, or Not Applicable (NA) thereby facilitating HCIM process 20 receiving 1508 indications of whether particular recommendations/orders/etc. have been complied with.

In certain embodiments, HCIM process 20 may provide 1514 a visual indicator that a target was not met. HCIM process may provide 1514 such indicator, in certain embodiments, based on a variety of information types, including, for example, date tracking information associated 904 with a clinical order. For example, visual indicator 1606 may indicate, based on date tracking information, that the associated clinical order contains a recommendation or target that was not met by the associated deadline. For example, based on input from the provider during this session, HCIM process 20 may determine that the patient's pain was not controlled to an acceptable level within at least 30 days.

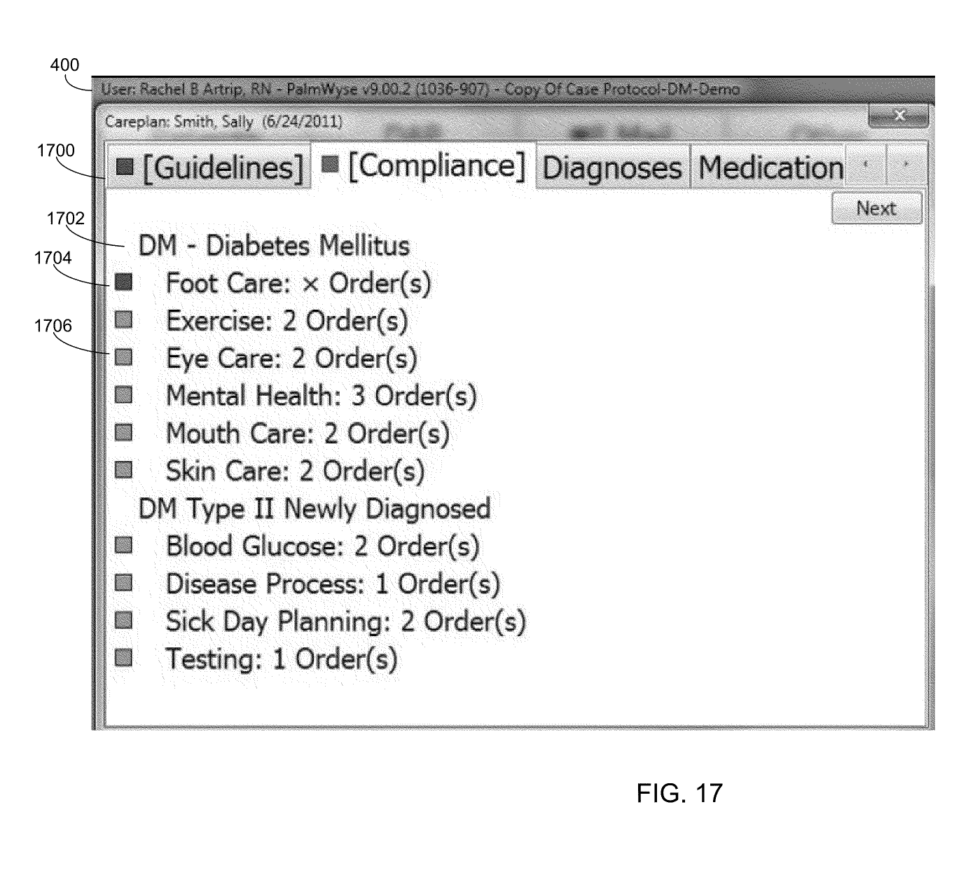

Referring now also to FIG. 17, HCIM process 20 may provide 1514 a variety of visual indicators that a target was not met or that a target needs to be addressed in a particular session. HCIM process 20 may, in certain embodiments, organize such indicators by category, condition characteristic, or other factor. For example, in window 1700, HCIM process 20 may indicate, as part of macro condition category 1702 (DM—Diabetes Mellitus), that sub-condition category Foot Care 1704 is not appropriately addressed by any clinical order and therefore should be addressed promptly, whereas sub-condition category Eye Care 1706 has been appropriately addressed by two clinical orders.

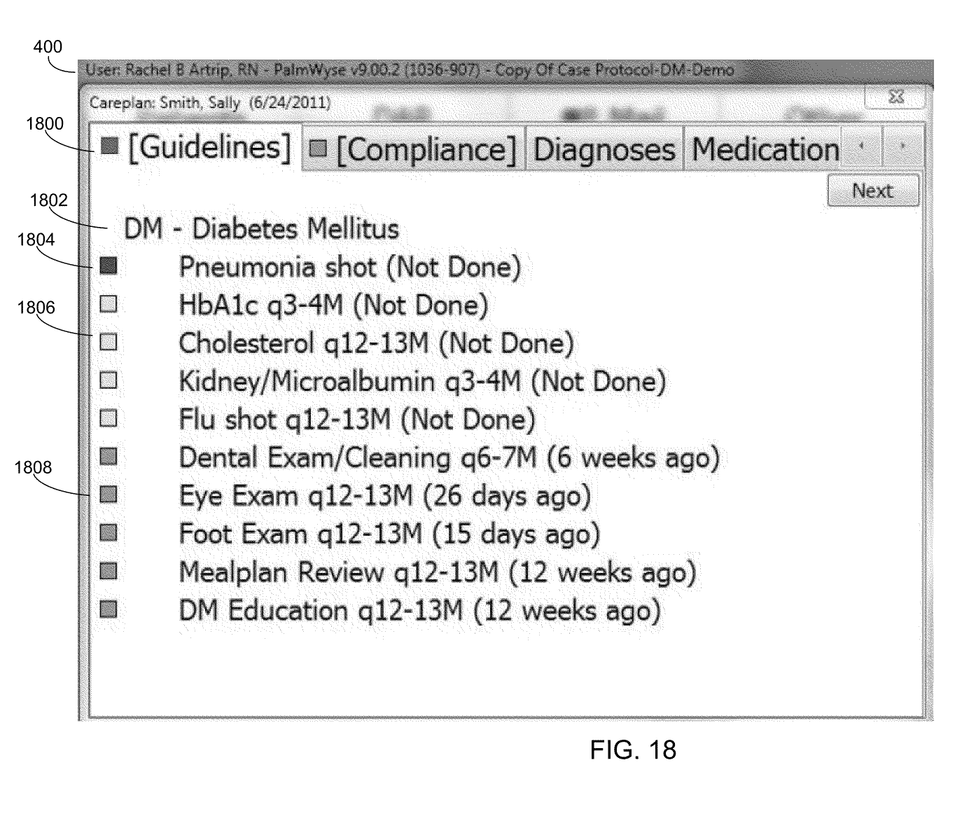

Referring now also to FIG. 18, in window 1800 HCIM process may provide 1514 a visual indicator that, within macro condition category 1802, high priority item 1804 (Pneumonia shot) has not yet been fulfilled, medium priority item 1806 (Cholesterol q12-13M) has not yet been fulfilled, and item 1808 (Eye Exam) was fulfilled 26 days ago.

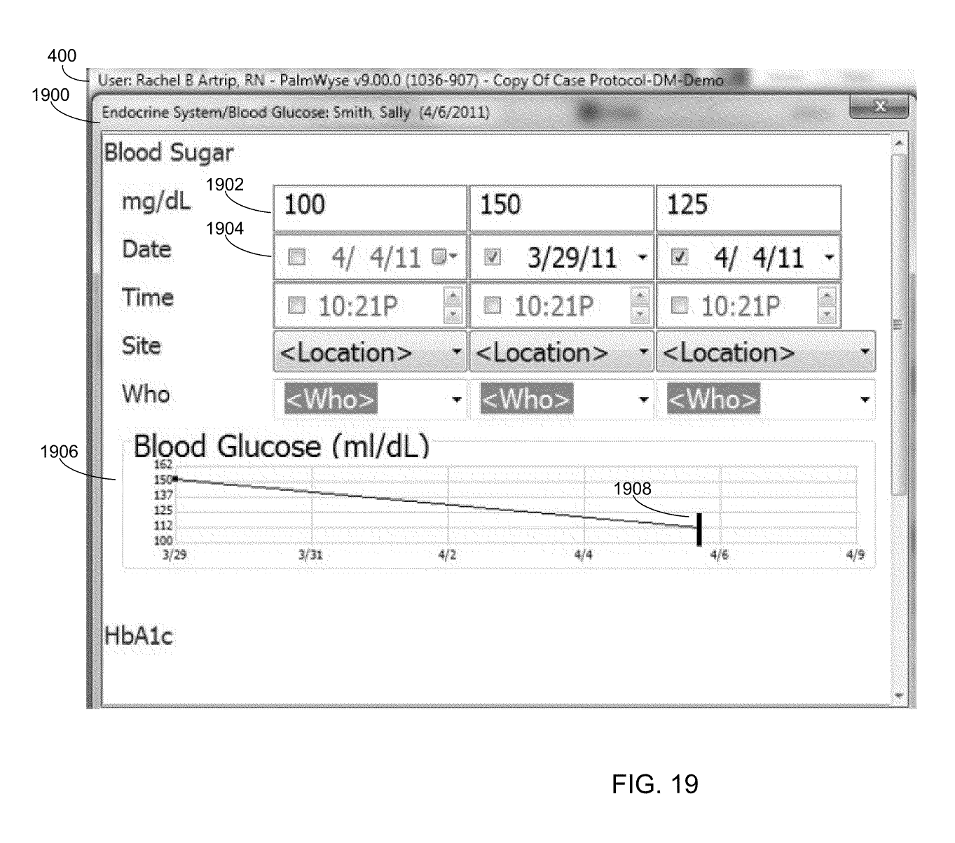

Referring now also to FIG. 19, HCIM process 20 may provide 1514 a representation 1516 of a historical compliance (or non-compliance) trend. For example, within window 1900, HCIM process 20 may accept input of (or may receive from a patient record) historical blood sugar levels 1902 associated with historical dates 1904. Based on this information, HCIM process 20 may provide 1514 representation 1906 of a historical trend of blood sugar level. Comparison of this information with target information (not shown) may permit a provider to assess historical trends of compliance (or non-compliance). In certain embodiments, HCIM process may, for example, extrapolate historical trends into future dates (e.g., extrapolation 1908 past the last date for which blood sugar information is available), which may permit a provider to identify potential future problems if historical trends continue.

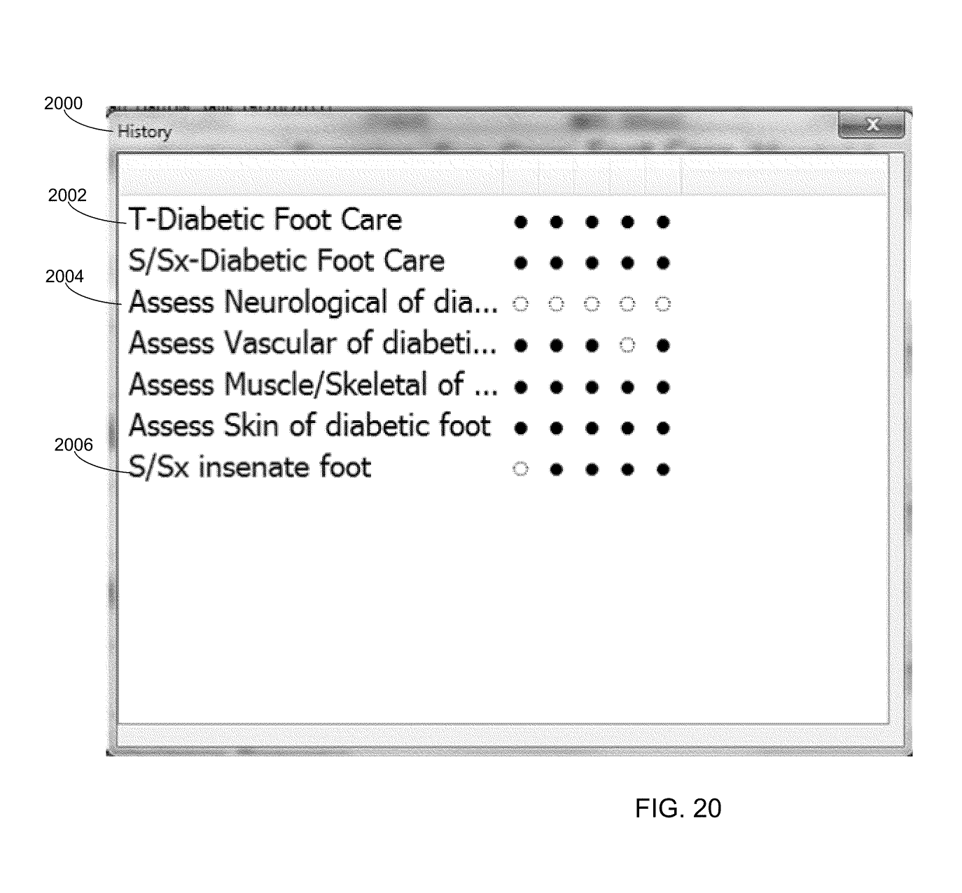

HCIM process 20 may provide 1514 various different representation of a historical compliance (or non-compliance) trend. For example, referring now also to FIG. 20, HCIM process 20 may indicate in row 2002 of history window 2000 (based, for example, on patient record, clinical order, or other information) that Foot Care objectives were met in all five of the most recent treatment sessions. HCIM process 20 may further indicate in row 2004 that Neurological Assessment objectives were not met in any of the five most recent sessions, and may indicate in row 2006 that another foot objective was met in the four most recent sessions, but not the session preceding them.

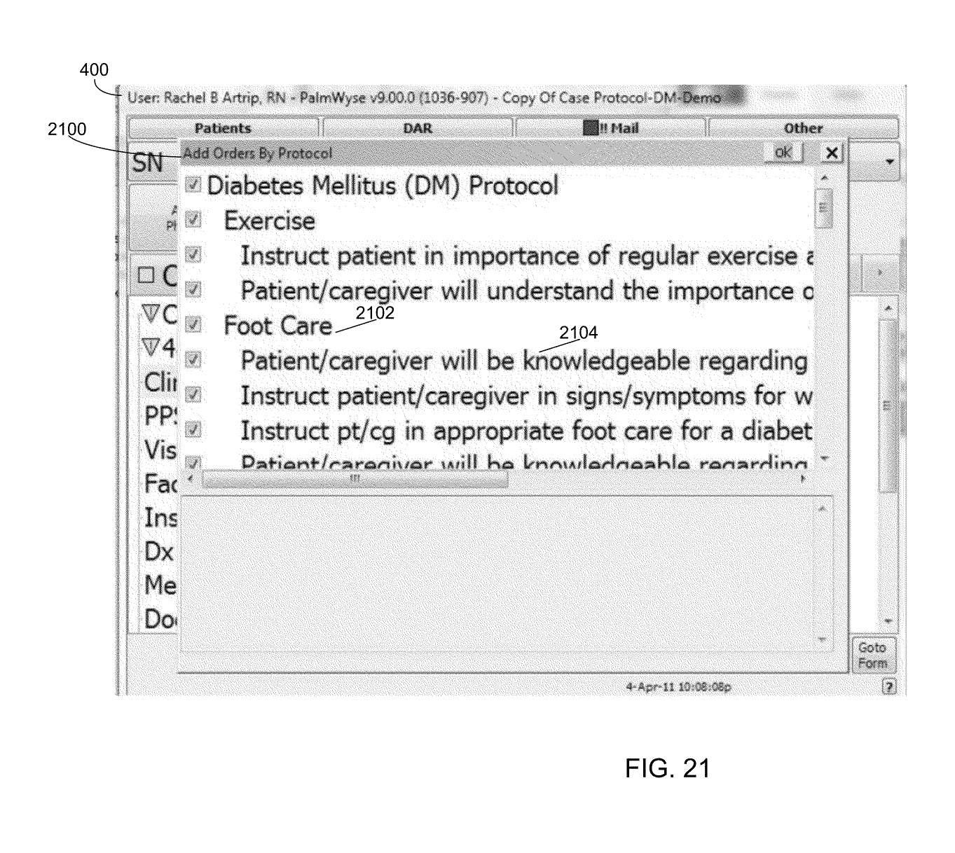

Referring now also to FIG. 21, HCIM process 20 may receive 1508 compliance indications based on, for example, input from a provider associated with clinical orders organized by category. For example, a provider may indicate as part of a session that various clinical orders (e.g., all Foot Care orders 2102) were fulfilled or that a particular order (e.g., order 2104) needs to be fulfilled. This information may then inform HCIM process 20 identifying 1510 instances of non-compliance.

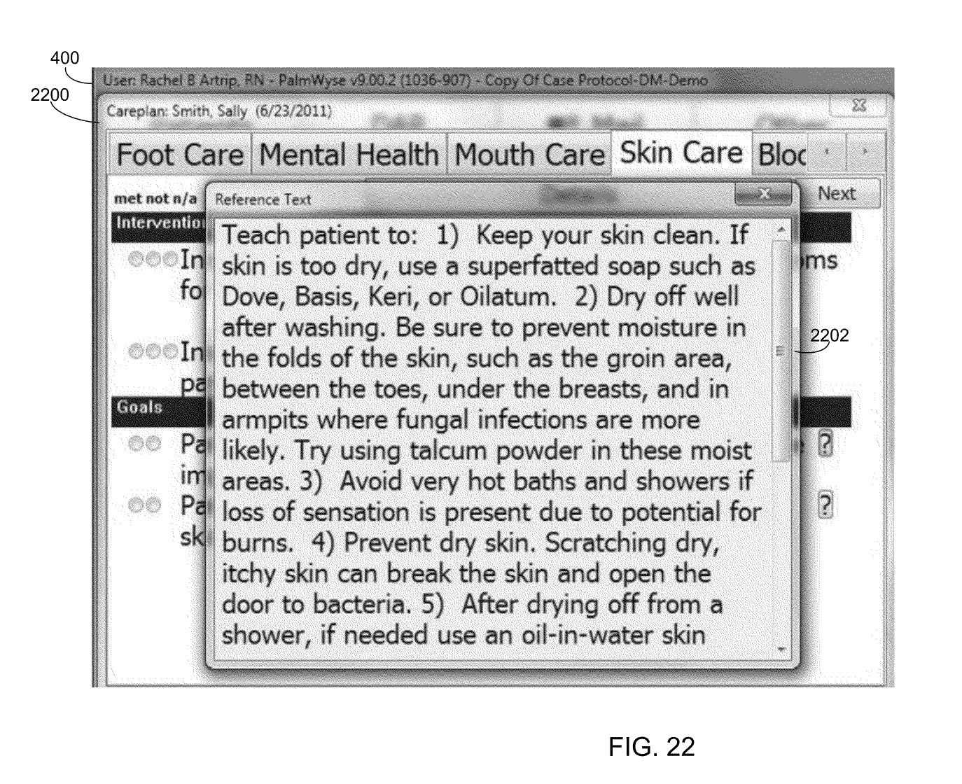

Referring now also to FIG. 22, providing 1518 recommendations for a treatment session may include providing 1522 to the provider (or other individual) education materials 2202. In certain embodiments, HCIM process 20 may facilitate printing (or electronically transferring) education materials (e.g., education materials 2202) so that a patient may review the materials at later times as well as during the current visit.

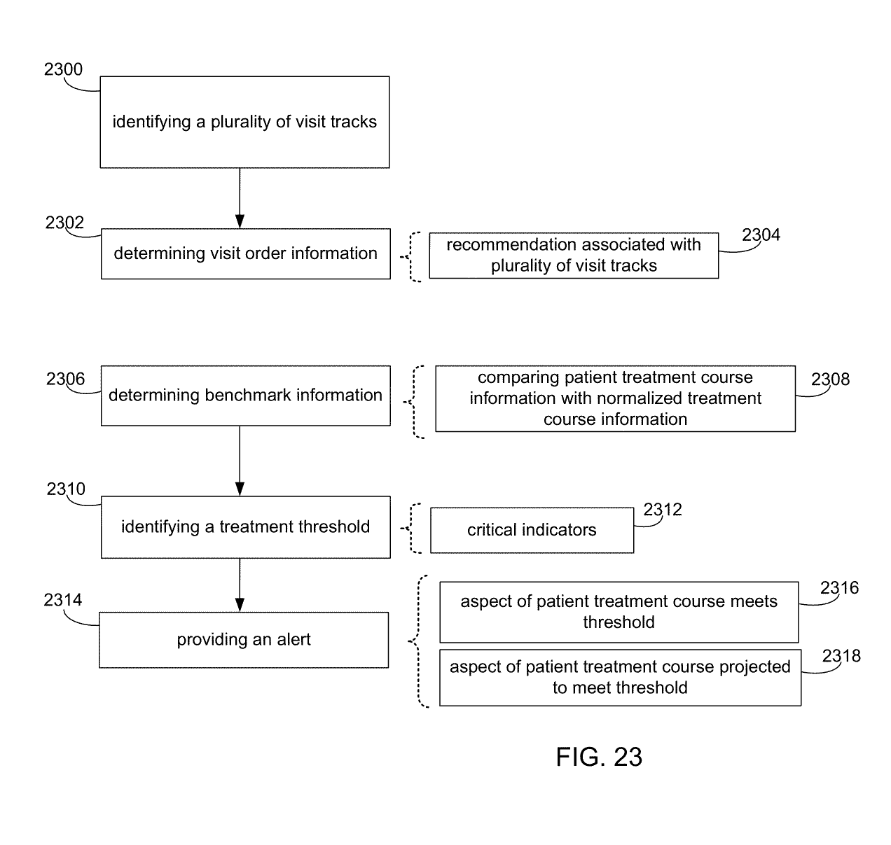

Referring now also to FIG. 23, HCIM process 20 may include identifying 2300 a plurality of visit tracks. A visit track may be a record of the timing and frequency of visits associated with a particular health care activity, such as conducting a treatment regimen, executing an evaluation protocol, administering medication, and so on. HCIM process 20 may identify 2300 visit tracks based on, for example, receiving 208 input from a provider relating to planned visit tracks, receiving 900 one or more clinical orders, and/or various other information.

Where multiple visit tracks have been associated with a particular patient, it may be useful to organize the occurrence of various visits associated with the various visit tracks so as to minimize the cost, inconvenience, and so on of the multiple visits. Accordingly, HCIM process 20 may determine 2302 visit order information 224 (including recommendations 2304 associated with, for example, the actual dates of the visits, the services to be performed at each visit, the frequency of visits, and so on) that are to be provided 204 to the provider (or other individual).

HCIM process 20 may receive various tracks of visits associated with a patient which may be received 208 specifically or may be derived from other information such as, for example, various coding, clinical orders, visit orders and so on. HCIM process 20 may then apply various rules in order to combine and/or overlay the various visit tracks and calculate a recommended 2304 visit schedule. For example, HCIM process 20 may recommend 2304 a consolidated/conglomerate visit order that balances the cost savings associated with minimizing the total number of visits with the health services objective of ensuring that all visit and clinical orders and/or requirements are complied with.

In order to recommend 2304 a consolidated/conglomerate visit order HCIM process 20 may evaluate a variety of information including, for example, aspects of a patient's condition and co-morbidity, a patient's progression in treatment, the equipment in place for a patient (e.g., availability of home blood pressure monitors), the maximum number of visits specified by various protocols, and so on. For example, in one embodiment, HCIM process 20 may identify, for each week, the treatment protocol involving the greatest number of visits (i.e, the “master” protocol) and may set the total number of visits for the week equal to the visits required by that protocol. HCIM process 20 may the allocate the visits of the remaining protocols (which require the same or fewer number of visits for the given week than the master protocol) to the various visits of the master protocol, thereby avoiding excessive visits while ensuring that no protocol is deprived of the necessary number of visits.

HCIM process 20 may determine 2306 benchmarking information. Benchmarking information may be information that facilitates comparison of patient record information (e.g., compliance rates, success in treatment of condition characteristics and co-morbidities, and so on) with various other information. Benchmarking information may facilitate, for example, comparison of information associated with a particular patient or cohort of patients, with normalized treatment course information for a different and/or larger cohort of patients. For example, HCIM process 20 may compare 2308 patient treatment course information (e.g., the historical progression of various indicators and information categories associated with treatment of a patient) with normalized treatment course information (e.g., the average historical progression of various indicators and information categories associated with a cohort of patients). For example, in order to facilitate assessment of the efficacy of an agency's treatment of one or more of its patients, HCIM process 20 may compare 2308 treatment course information (e.g., hospitalization rates, compliance levels, indicators associated with condition characteristics, and so on) associated with the one or more patients with average treatment course information for a set of geographically or demographically similar individuals (e.g., a group of individuals representing an entire health care system, an entire region, an entire nation, and so on) and may present such comparison in a variety of ways (e.g., pictorially, graphically, in tables, and so on). As such, HCIM process 20 may determine a set of patients exhibiting similar conditions or other characteristics (e.g., similar coding, similar stage in condition progression, medication course, etc.) to the target patient (or patient cohort) that an agency intends to evaluate and may display target patient (or patient cohort) information benchmarked against such other patients.

In certain embodiments, HCIM process 20 may additionally/alternatively present target patient (or patient cohort) information with respect to, for example, evidence-based protocols. For example, HCIM process 20 may present a plot indicating, with respect to recommended outcomes, recommended compliance levels, and so on the actual outcomes, compliance levels, and so on, of the target patient (or patient cohort).

As part of benchmarking, HCIM process 20 may identify 2310 a treatment threshold associated with one or more critical indicators 2312 (e.g., a compliance level, test score, condition characteristic measurement, and so on) associated with a patient or patient record. HCIM process 20 may then provide 2314 an alert based upon determining whether an aspect of the target patient treatment course information has met 2316 (or exceeded) the threshold and/or whether an aspect of the patient treatment course information is projected to meet 2318 the threshold. For example, HCIM process 20 may identify 2310 (e.g., based on clinical authority information 206) that 80% compliance with a medication dose regimen indicates a threshold (i.e., the lowest acceptable compliance level) for a particular treatment. HCIM process 20 may determine whether the actual compliance level (i.e., the relevant aspect of the patient treatment course) meets or is projected to meet the threshold, and may provide 2314 an alert based on that determination.

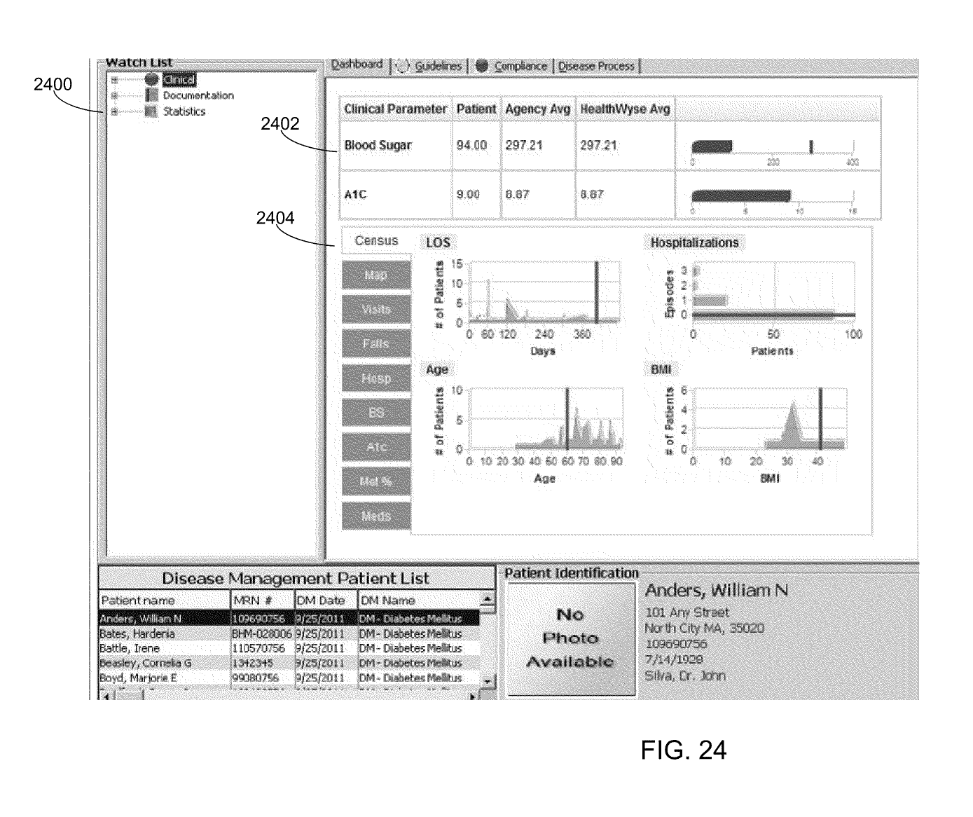

Referring now also to FIG. 24, HCIM process 20 may provide benchmarking display window 2400, which may include, for example, representation of relevant patient treatment course information (e.g., blood sugar information 2402) as well as comparable information relating to a comparison cohort (e.g., the average blood sugar information for all patients affiliated with a health care agency). HCIM process 20 may additionally/alternatively provide various other benchmarking information and functionality. For example, HCIM process 20 may permit users to select from a variety of cohorts and display settings 2404 in order to display relevant benchmarking comparisons by information type, cohort type, agency type, comparison type, and so on.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of embodiments and implementations have been described. Nevertheless, it will be understood that various modifications may be made. Accordingly, other embodiments and implementations are within the scope of the following claims.

What is claimed is:

1. A computer-implemented method comprising:
identifying, by one or more computing devices, a patient condition associated with a patient record based upon, at least in part, a first input associated with the patient record;
providing, by the one or more computing devices, a point-of-care prompt based upon, at least in part, the patient condition and clinical authority information;
receiving in response to the point-of-care prompt, by the one or more computing devices, a point-of-care input associated with, at least in part, one or more of a first education material, a first condition assessment, first co-morbidity information, a first diagnosis protocol, a first treatment protocol, first medication information, first clinical order information, first visit order information, patient resource information, and first care planning information; and
providing treatment information, by the one or more computing devices, based upon, at least in part, the point-of-care input, wherein the treatment information is associated with clinical authority information and one or more of a second education material, a second condition assessment, a second co-morbidity, a second diagnosis protocol, a second treatment protocol, second medication information, second clinical order information, second visit order information, second care planning information, and benchmarking information.

2. The computer-implemented method of claim 1 further comprising:
identifying one or more of historical diagnosis information and historical treatment information,
wherein providing the treatment information is based upon, at least in part, one or more of the historical diagnosis information and the historical treatment information.

3. The computer-implemented method of claim 1 wherein providing the point-of-care prompt includes, at least in part, providing a hierarchical input architecture associated one or more patient condition characteristics, and
wherein the one or more patient condition characteristics are based upon, at least in part, one or more of the clinical authority information and the patient condition.

4. The computer-implemented method of claim 3 further comprising:
receiving a selection of one or more nested categories associated with the hierarchical input architecture, and
providing one or more additional input prompts based upon, at least in part, the selection, wherein the one or more additional input prompts are associated with the one or more condition characteristics.

5. The computer-implemented method of claim 4 further comprising:
identifying one or more coding requirements based upon, at least in part, the selection of the one or more nested categories; and
determining whether the one or more coding requirements has been met.

6. The computer-implemented method of claim 4 further comprising:
providing a drawing template based upon, at least in part, the selection of the one or more nested categories.

7. The computer-implemented method of claim 1 wherein providing treatment information further comprises:
receiving a first clinical order, including a text-based clinical order; and
associating the first clinical order with an order category.

9. The computer-implemented method of claim 7 further comprising:
associating date tracking information with the first clinical order.

10. The computer-implemented method of claim 9 further comprising:
determining whether an event associated with the date tracking information occurs before passage of a deadline associated with the date tracking information; and
if the event does not occur before the passage of the deadline, providing a prompt associated with non-occurrence of the event; and
if the event does occur before the passage of the deadline, associating an indicator of an occurrence of the event with the patient record.

11. The computer-implemented method of claim 7 further comprising:
identifying a need associated with the patient condition; and
associating with the first clinical order a recommended order element associated with the need.

12. The computer-implemented method of claim 7 further comprising:
receiving a second clinical order including a text-based clinical order;
identifying an association between the first clinical order and the second clinical order; and
merging the first clinical order and the second clinical order based upon, at least in part, identifying the association.

13. The computer-implemented method of claim 1 wherein the first medication information includes one or more of a medication type and medication dose regimen information.

14. The computer-implemented method of claim 13 wherein the second medication information includes one or more recommendations associated with an additional medication, wherein the recommendation is associated with one or more of the medication type, the medication dose regimen information, and a characteristic associated with the patient condition.

15. The computer-implemented method of claim 13 further comprising:
providing teaching information regarding one or more of the medication type and the medication dose regimen information.

16. The computer-implemented method of claim 13 further comprising:
receiving medication usage information; and
determining a compliance level associated with a medication regimen based upon, at least in part, the medication dose regimen information and the medication usage information;

17. The computer-implemented method of claim 16 further comprising:
plotting the compliance level with respect to one or more medication effect parameters.

18. The computer-implemented method of claim 1 wherein the second treatment protocol includes one or more identifications of unnecessary treatment activities.

19. The computer-implemented method of claim 1 further comprising:
providing the treatment information at one or more of the point of care and a remote location.

20. The computer-implemented method of claim 1 further comprising:
receiving one or more compliance indications associated with one or more aspects of a recommended treatment course, wherein the treatment information includes the recommend treatment course.

21. The computer-implemented method of claim 20 further comprising:
identifying one or more instances of non-compliance with the one or more aspects of a recommended treatment course based upon, at least in part, comparing the one or more indications of compliance with the recommended treatment course; and
providing a visual indicator of the one or more instances of non-compliance.

22. The computer-implemented method of claim 21 wherein the visual indicator includes a representation of one or more historical compliance trends.

23. The computer-implemented method of claim 21 further comprising:
providing one or more recommendations for a treatment session based upon, at least in part, one or more of the clinical authority information, identifying the one or more instances of non-compliance, and receiving one or more clinical orders.

24. The computer-implemented method of claim 23 wherein providing the one or more recommendations further comprises:
grouping a set of clinical orders for presentation by subject matter category.

25. The computer-implemented method of claim 23 wherein providing the one or more recommendations further comprises:
providing relevant education materials, based upon, at least in part, one or more of the clinical authority information and the patient condition.

26. The computer-implemented method of claim 1 further comprising:
identifying a plurality of visit tracks; and
determining the second visit order information based upon, at least in part, identifying the plurality of visit tracks,
wherein the second visit order information includes a recommendation associated with the plurality of visit tracks.

27. The computer-implemented method of claim 1 further comprising:
determining benchmarking information based upon, at least in part, comparing patient treatment course information with normalized treatment course information.

28. The computer-implemented method of claim 27 further comprising:
identifying a treatment threshold associated with one or more critical indicators; and
providing an alert based upon, at least in part, one or more of determining that a first aspect of the patient treatment course information has met the threshold and determining that a second aspect of the patient treatment course information is projected to meet the threshold.

29. A computer program product residing on a non-transitory computer readable medium having a plurality of instructions stored thereon, which, when executed by a processor, cause the processor to perform operations comprising:
identifying a patient condition associated with a patient record based upon, at least in part, a first input associated with the patient record;
providing a point-of-care prompt based upon, at least in part, the patient condition and clinical authority information;
receiving in response to the point-of-care prompt a point-of-care input associated with, at least in part, one or more of a first education material, a first condition assessment, first co-morbidity information, a first diagnosis protocol, a first treatment protocol, first medication information, first clinical order information, first visit order information, patient resource information, and first care planning information; and
providing treatment information based upon, at least in part, the point-of-care input, wherein the treatment information is associated with clinical authority information and one or more of a second education material, a second condition assessment, a second co-morbidity, a second diagnosis protocol, a second treatment protocol, second medication information, second clinical order information, second visit order information, second care planning information, and benchmarking information.

30. A computer system comprising:
one or more processors; and
one or more memory architectures coupled with the one or more processors;
wherein the one or more processors are configured to:
identify a patient condition associated with a patient record based upon, at least in part, a first input associated with the patient record;
provide a point-of-care prompt based upon, at least in part, the patient condition and clinical authority information;
receive in response to the point-of-care prompt a point-of-care input associated with, at least in part, one or more of a first education material, a first condition assessment, first co-morbidity information, a first diagnosis protocol, a first treatment protocol, first medication information, first clinical order information, first visit order information, patient resource information, and first care planning information; and
provide treatment information based upon, at least in part, the point-of-care input, wherein the treatment information is associated with clinical authority information and one or more of a second education material, a second condition assessment, a second co-morbidity, a second diagnosis protocol, a second treatment protocol, second medication information, second clinical order information, second visit order information, second care planning information, and benchmarking information.
